(19) United States
(12) Patent Application Publication
(10) Pub. No.: US 2026/0267628 A1
(43) Pub. Date: Sep. 10, 2026

(54) SYSTEM, IMPROVEMENT METHOD, AND DRIVING SYSTEM

(71) Applicant: DENSO CORPORATION, Kariya-city (JP)

(72) Inventor: Atsushi BABA, Kariya-city (JP)

(21) Appl. No.: 19/462,642

(22) Filed: Jan. 28, 2026

Related U.S. Application Data
(63) Continuation of application No. PCT/JP2024/025491, filed on Jul. 16, 2024.

(30) Foreign Application Priority Data
Aug. 4, 2023 (JP) 2023-128125

(51) Int. Cl. G06F 8/61; G06F 11/3668

(52) U.S. Cl. CPC G06F 8/61; G06F 11/3688; G06F 11/3692

(57) ABSTRACT

An improvement system for improving a driving system includes a plurality of vehicles each equipped with the driving system, and a server communicably connected to the plurality of vehicles. The server sets a plurality of pieces of test software to be tested on the driving system, and allocates one of the plurality of pieces of test software to each of the plurality of vehicles, and transmits the allocated test software to each of the driving systems. Each driving system temporarily applies the allocated test software and measures an index related to safety or data necessary for calculation of the index, and transmits measured measurement information to the server. The server analyzes the index related to safety for each piece of the test software and determines formal software, and transmits the formal software to each driving system. Each driving system applies the received formal software.

### CROSS REFERENCE TO RELATED APPLICATION

The present application is a continuation application of International Patent Application No. PCT/JP2024/025491 filed on Jul. 16, 2024 which designated the U. S. and claims the benefit of priority from Japanese Patent Application No. 2023-128125 filed on Aug. 4, 2023. The entire disclosures of all of the above applications are incorporated herein by reference.

### TECHNICAL FIELD

The disclosure in this description relates to a technique for improving performance of a driving system in a vehicle.

### BACKGROUND

A related art discloses a system for driving a vehicle. In this system, a safety model such as a driving policy and an RSS model is implemented as software, making a system applicable to several millions of vehicles conforming to the requirements of safety statements.

### SUMMARY

According to an aspect of the present disclosure, an improvement system for improving a driving system is provided. The improvement system includes a plurality of vehicles each equipped with the driving system, and a server communicably connected to the plurality of vehicles. The server may set a plurality of pieces of test software to be tested on the driving system, and allocate one of the plurality of pieces of test software to each of the plurality of vehicles, and transmit the allocated test software to each of the driving systems. Each driving system may temporarily apply the allocated test software from among the plurality of pieces of test software, and measure an index related to safety or data necessary for calculation of the index under application of the test software, and transmit measured measurement information to the server. The server may analyze the index related to safety for each piece of the test software based on the measurement information collected from each driving system and determine one of the plurality of pieces of test software to be formally adopted as formal software, and transmit the formal software to each driving system. Each driving system may apply the received formal software.

### BRIEF DESCRIPTION OF DRAWINGS

Objects, features and advantages of the present disclosure will become more apparent from the following detailed description made with reference to the accompanying drawings. In the drawings:

FIG. 1 is a diagram illustrating an example of a schematic configuration of a driving system;

FIG. 2 is a diagram illustrating an example of a hardware configuration of the driving system;

FIG. 3 is a diagram illustrating an example of a functional configuration of the driving system;

FIG. 4 is a diagram illustrating a longitudinal safety distance;

FIG. 5 is a diagram illustrating a longitudinal safety distance;

FIG. 6 is a diagram illustrating a lateral safety distance;

FIG. 7 is a diagram illustrating a lane-based coordinate system;

FIG. 8 is a flowchart illustrating a process performed by the driving system;

FIG. 9 is a diagram illustrating an example of a configuration of the driving system;

FIG. 10 is a diagram illustrating an example of a schematic configuration of a management system;

FIG. 11 is a flowchart illustrating a process performed by the management system;

FIG. 12 is a diagram illustrating an example of a test using a shadow-mode;

FIG. 13 is a diagram illustrating an example of a test using a redundant system;

FIG. 14 is a diagram illustrating an example of an HMI test;

FIG. 15 is a diagram illustrating an example of another test;

FIG. 16 is a diagram illustrating an example of another test; and

FIG. 17 is a diagram illustrating an example of another test.

### DETAILED DESCRIPTION

It is required to execute a verification and validation (V&V) process and execute an improvement on such a driving system.

The present disclosure provides an improvement system and an improvement method for improving the performance of a driving system, and a driving system suitable therefor.

According to one aspect of the present disclosure, an improvement system for improving a driving system is provided. The improvement system includes: a plurality of vehicles each equipped with the driving system; and a server communicably connected to the plurality of vehicles. The server sets a plurality of pieces of test software to be tested on the driving system, and allocates one of the plurality of pieces of test software to each of the plurality of vehicles, and transmits the allocated test software to each of the driving systems. Each driving system temporarily applies the allocated test software from among the plurality of pieces of test software, and measures an index related to safety or data necessary for calculation of the index under application of the test software, and transmits measured measurement information to the server. The server analyzes the index related to safety for each piece of the test software based on the measurement information collected from each driving system and determines one of the plurality of pieces of test software to be formally adopted as formal software, and transmits the formal software to each driving system. Each driving system applies the received formal software.

According to one aspect of the present disclosure, an improvement method for improving a driving system, the improvement method being executed by an improvement system including a plurality of vehicles equipped with the driving system, and a server communicably connected to the plurality of vehicles, is provided. The improvement method includes: by the server, setting a plurality of pieces of test software to be tested on the driving system, allocating one of the plurality of pieces of test software to each of the plurality of vehicles, and transmitting the allocated test software to each of the driving systems; by each driving system, temporarily applying the allocated test software from among the plurality of pieces of test software, measuring an index related to safety or data necessary for calculation of the index under application of the test software under the application of the test software, and transmitting measured measurement information to the server; by the server, analyzing the index related to safety for each piece of the test software based on the measurement information collected from each driving system, determining one of the plurality of pieces of test software to be formally adopted as formal software, and transmitting the formal software to each driving system; and applying the received formal software by each driving system.

According to one aspect of the present disclosure, a driving system for implementing a dynamic driving task of a vehicle by executing a plurality of pieces of software by at least one processor is provided. The driving system includes: a communication system mounted on the vehicle and configured to communicate with a server; the at least one processor; and at least one storage medium configured to store the plurality of pieces of software. The at least one processor acquires allocated test software related to execution of the dynamic driving task via the communication system from the server, temporarily applies the test software to the at least one storage medium, measures an index related to safety or data necessary for calculation of the index in the execution of the dynamic driving task under the application of the test software, transmits measured measurement information to the server via the communication system, acquires, from the server in which formal software to be formally adopted is determined based on the measurement information, the formal software via the communication system, and applies the formal software to the at least one storage medium.

According to these aspects, multiple different pieces of test software are allocated to driving systems in multiple vehicles, and a test is executed in each driving system. An index related to safety measured in each driving system or data necessary for calculation of the index is collected by a server, and multiple pieces of test software are evaluated by the index related to safety. In this way, the optimum test software can be selected based on the statistical approach, and the optimum test software is applied to each vehicle as formal software. Accordingly, the performance of the driving system of each vehicle can be effectively improved.

Hereinafter, multiple embodiments will be described with reference to the drawings. Duplicate description may be omitted by assigning the same reference numerals to the corresponding elements in each embodiment. When only a part of a configuration is described in each embodiment, the configurations of the other embodiments described above can be applied to the other parts of the configuration. In addition, configurations specified in the description of each embodiment can be combined, and especially, configurations of multiple embodiments can be partially combined even though not specified herein so long as no problem occurs in the combination thereof.

In the following multiple embodiments, contents of “Safety First for Automated Driving” Tech. Rep., 2019, by Aptiv, Audi, Baidu, BMW, Continental, Daimler, FCA, here, Infineon, Intel, and Volkswagen, contents of “On a formal model of safe and scalable self-driving cars”, arXiv:1708.06374, 2017, by S. Shalev-Shwartz, S. Shammah, and A. Shashua, contents of “The Safety Force Field” Technical Report, 2019, by David Nister, Hon-Leung Lee, Julia Ng, Yizhou Wang, contents of IEEE 2846-2022 are incorporated by reference in their entirety.

### DESCRIPTION OF TERMS

The following describes terms related to this disclosure in this description. This description is included in the embodiments of this disclosure.

A road user may be a traffic participant on or adjacent to an active road for the purpose of moving from a certain place to another place.

A dynamic driving task (DDT) may be a real-time operation functionality and a real-time strategic functionality for operating a vehicle in traffic. The dynamic driving task may be all real-time operation functionalities and real-time strategic functionalities for operating the vehicle on the road.

An automated driving system (ADS) may be a batch of hardware and software capable of continuously executing the entire DDT regardless of whether the automated driving system is limited to a specific operational design domain.

ADS functionality (ADS feature) may be design-specific functionality of the ADS in a specific ODD at a predetermined automated driving level.

A DDT fallback may be a response by a driver or an automated system to either execute a DDT or transition to a minimal risk condition after a failure occurs or upon detection of a functional insufficiency or a potentially hazardous behavior. The DDT fallback may be a method of transition control from autonomy to control by a driver or other system using takeover/fallback states and associated use cases. The DDT fallback may be a response by the user for executing the DDT or achieving an MRC after the occurrence of a system failure related to the DDT performance or during deviation from the ODD, or a response by the ADS for achieving the MRC when placed in the same situation.

The minimal risk condition (MRC) may be a vehicle state in order to reduce the risk, when a predetermined trip cannot be completed. The minimal risk condition may be a stable stop state that the user or the ADS brings to the vehicle after the DDT fallback is executed in order to reduce the risk of an accident when the predetermined trip cannot or should not be continued.

The operational design domain (ODD) may be a specific condition which is designed such that a predetermined (automated) driving system functionalities. The operational design domain is an operation condition specially designed such that a predetermined ADS or a functionality thereof functions, and includes, but is not limited to, the presence or absence of requirements of environmental, geography, and time zone restrictions, and/or certain traffic/road properties.

Safety of the intended functionality (SOTIF) may mean absence of an unreasonable risk caused by functional insufficiency for an intended functionality or implementation thereof.

A driving policy may be a strategy and a rule defining a control action at a vehicle level.

A situation is a factor that can affect a behavior of a system, and may include traffic situations, weather, and the behavior of the ego-vehicle.

A scenario may be a description of the temporal relationships between several scenes in a series of scenes, including goals and values in a specific situation influenced by actions and events. The scenario may be a description of consecutive activities in time series in which a vehicle as a main-object, all external environments thereof, and interactions thereof in a process of executing a specific driving task are integrated.

A safety-relevant object may be any moving or static object that may be relevant to the safety performance of the DDT.

The term “reasonably foreseeable” may mean being technically reliable and having a credible or measurable occurrence rate.

A triggering condition may be a specific condition of a scenario functioning as a trigger for a response that is a response of a subsequent system and that contributes to inability to prevent, detect, and reduce hazardous behaviors and reasonably foreseeable indirect misuse.

The safety-related model may be representation of a safety-related aspect of the driving action based on assumptions on the reasonably foreseeable behavior of other road users. The safety-related model may be an on-board or off-board safety checker or an on-board or off-board safety analysis device, a mathematical model, a set of more conceptual rules, a set of scenario-based behavior, or a combination thereof.

A formal model may be a model represented in a formal representation used for system performance verification.

A safety envelope may be a set of restrictions and conditions that are designed for a (automated) driving system to operate as a target for a constraint or a control in order to maintain an operation at an acceptable risk level. The safety envelope may be a general concept that can be used to deal with all principles on which the driving policy can be based. According to this concept, an ego-vehicle operated by the (automated) driving system can have one or multiple boundaries around the ego-vehicle.

A response time may be a time required for the road user to sense a specific stimulus and start executing a response (braking, steering, acceleration, stopping, or the like) in a predetermined scenario.

The risk acceptance criteria/criterion are/is criteria/a criterion indicating that there is no unreasonable level of risk, and may be, for example, a physical parameter defining when a specific behavior is regarded as a hazardous behavior, the maximum number of incidents per hour, as low as reasonably practicable.

The positive risk balance may be a criterion to demonstrate that a technical solution achieves an acceptable level of residual risk.

A vulnerable road user (VRU) may be a road user not in vehicles such as a car, a public transport agency, or a train. The vulnerable road user may be an unprotected road user, such as a motorcyclist, a cyclist, a pedestrian, or a person with a disability or with reduced mobility and orientation.

A proper response may be an action that is significant to avoid and ameliorate a hazardous situation in a reasonably foreseeable scenario in which other safety-relevant objects are operating within an assumption range.

The object and event detection and response (OEDR) may be a sub-task of the DDT including monitoring the driving environment and executing an appropriate response to such an object or event.

### First Embodiment

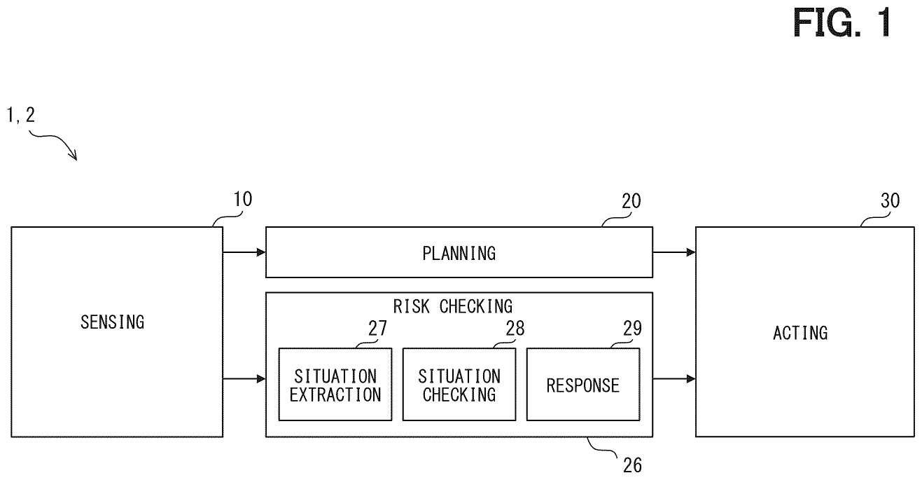

A driving system 2 of a first embodiment illustrated in FIG. 1 implements functionalities related to driving a vehicle 1. A part or all of the driving system 2 is mounted on the vehicle 1. The vehicle 1 may be referred to as an ego-vehicle, a host vehicle, or the like. The vehicle 1 may be configured to communicate with another vehicle or the like directly or indirectly via communication infrastructure. The other vehicle is referred to as a target vehicle in some cases.

The vehicle 1 may be, for example, a road user capable of executing manual driving of a four-wheeled automobile or a truck. The vehicle 1 may further be capable of executing automated driving. The automated driving may be referred to as autonomous driving by the driving system 2. Levels of the driving are classified in accordance with a range or the like of tasks executed by a driver, among all dynamic driving tasks (DDTs). The automated driving level is defined, for example, in SAE J3016. At levels 0 to 2, the driver performs a part or all of the DDT. Levels 0 to 2 may be classified as so-called manual driving. Level 0 indicates that driving is not automated. Level 1 indicates that the driving system 2 supports the driver. Level 2 indicates that driving is partially automated.

At level 3 or higher, the driving system 2 performs the entire DDT while the ADS functionality (ADS feature) is operating. Levels 3 to 5 may be classified as so-called automated driving. Systems capable of executing driving at level 3 or higher may be referred to as automated driving systems (ADS). A vehicle on which an automated driving system is mounted or a vehicle capable of executing driving at level 3 or higher may be referred to as an automated vehicle (AV).

Level 3 indicates that driving is conditionally automated. The automated driving system at level 3 executes the DDT but does not execute the DDT fallback. That is, the DDT fallback is executed by a driver who is ready for fallback. Level 4 indicates that driving is highly automated. The automated driving system at level 4 executes the DDT and the DDT fallback. The automated driving system at level 4 can cause the driver to take over the DDT after reaching the minimal risk condition by executing the DDT fallback or the like. Level 5 indicates that driving is fully automated.

The conditions for executing automated driving at levels 3 and 4 may include some or all of the conditions indicated by the operational design domain (ODD). For example, the ADS functionality may be defined within the range of ODD.

The driving system 2 which is not capable of executing driving at level 3 or higher and which is capable of executing driving of at least one of levels 1 and 2 may be referred to as a driver-assistance system. In the following, especially when there is little need to specify the achievable level of automated driving, the automated driving system or the driver-assistance system may be simply referred to as the driving system 2.

### (Driving System Overview)

An architecture of the driving system 2 is selected such that an efficient safety of the intended functionality (SOTIF) process can be implemented. For example, the architecture of the driving system 2 may be configured based on a sense-plan-act model. The sense-plan-act model includes a sense element, a plan element, and an act element, as main system elements. The sense element, the plan element, and the act element interact with one another. The sense may be replaced with perception, the plan may be replaced with determination, and the act may be replaced with control, respectively.

In such a driving system 2, at a functional level (in other words, from a functional perspective), a sensing functionality, a planning functionality, and an acting functionality are implemented. At a technical level (in other words, a technical perspective), at least multiple sensors 40 corresponding to the sensing functionality, at least one processing system 50 corresponding to the planning functionality, and multiple motion actuators 60 corresponding to the acting functionality are implemented.

Specifically, a sensing unit 10 as a functional block for implementing the sensing functionality mainly using the multiple sensors 40, a processing system 50 that processes sense information of the multiple sensors 40, and a processing system 50 that generates an environment model based on information of the multiple sensors 40 may be constructed in the driving system 2. A planning unit 20 and a risk checking unit 26 as functional blocks that implement the planning functionality mainly using the processing system 50 may be constructed in the driving system 2. An acting unit 30 as a functional block for implementing the acting functionality mainly using multiple motion actuators 60 and at least one processing system that outputs an operation signal of the multiple motion actuators 60 may be constructed in the driving system 2.

The sensing unit 10 may be implemented in a form of a sensing system serving as a subsystem that is provided to be distinguishable from the planning unit 20 and the acting unit 30. The planning unit 20 may be implemented in a form of a planning system as a subsystem that is provided to be distinguishable from the sensing unit 10 and the acting unit 30. The planning system may include the risk checking unit 26. The acting unit 30 may be implemented in a form of an acting system serving as a subsystem that is provided to be distinguishable from the sensing unit 10 and the planning unit 20. The sensing system, the planning system, and the acting system may constitute independent components. The subsystem here may be replaced with a module, a unit, a device, or the like.

The sensing unit 10 serves as the sensing functionality including localization (for example, estimation of position) of a road user such as the vehicle 1 and another vehicle. The sensing unit 10 senses an external environment, an internal environment, and a vehicle state of the vehicle 1 and further, a state of the driving system 2. The sensing unit 10 fuses the sensed information to generate an environment model. The environment model may be referred to as a world model. The planning unit 20 applies a purpose and a driving policy to the environment model generated by the sensing unit 10 to derive a control action. The acting unit 30 executes the control action derived by the planning unit 20.

The risk checking unit 26 implements a risk checking functionality of checking a risk occurring in the vehicle 1. The risk checking unit 26 may be implemented independently of the planning unit 20 as illustrated in FIG. 1, or may be implemented as a part of the planning functionality of the planning unit 20.

### (Physical Architecture Overview)

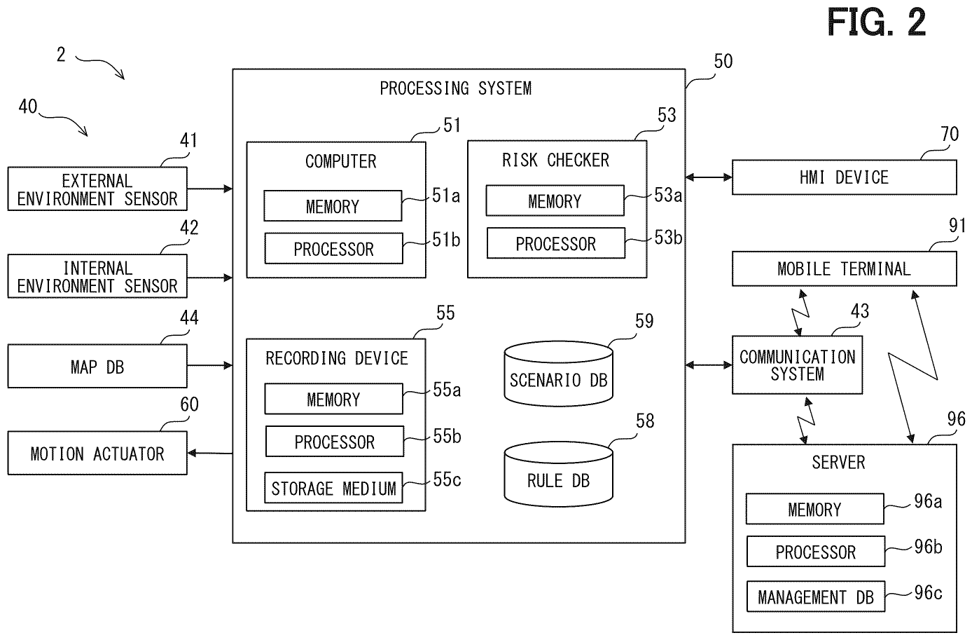

An example of a physical architecture of the driving system 2 will be described with reference to FIG. 2. The driving system 2 includes the multiple sensors 40, the multiple motion actuators 60, multiple HMI devices 70, and at least one processing system 50. These elements can communicate with each other through one or both of a wireless connection and a wired connection. These elements may be capable of communicating with each other through, for example, an in-vehicle network such as a CAN (registered trademark).

The multiple sensors 40 include one or multiple external environment sensors 41. The multiple sensors 40 may include at least one type among one or multiple internal environment sensors 42, one or multiple communication systems 43, and a map database (DB) 44.

The external environment sensor 41 may detect a target object present in the external environment of the vehicle 1. Examples of the external environment sensor 41 of a target object detection type include a camera, a light detection and ranging/laser imaging detection and ranging (LiDAR) laser radar, a millimeter wave radar, an ultrasonic sonar, and the like. Typically, a combination of multiple types of external environment sensors 41 may be mounted to monitor directions including a front direction, a side direction, and a rear direction of the vehicle 1.

The external environment sensor 41 may detect a state of an atmosphere or a state of weather in the external environment of the vehicle 1. The external environment sensor 41 of a state detection type is, for example, an outside air temperature sensor, a temperature sensor, or a raindrop sensor.

The internal environment sensor 42 may detect a specific physical quantity (hereinafter, a motion physical quantity) related to a vehicle motion in the internal environment of the vehicle 1. Examples of the internal environment sensor 42 of a motion physical quantity detection type include a velocity sensor, an acceleration sensor, a gyro sensor, and the like. The internal environment sensor 42 may detect a state of an occupant in the internal environment of the vehicle 1. The internal environment sensor 42 of an occupant detection type is, for example, an actuator sensor, a driver monitoring sensor and a system thereof, a biometric sensor, a seating sensor, or an in-vehicle device sensor. In particular, examples of the actuator sensor include an accelerator sensor, a brake sensor, a steering sensor, and the like that detect an operation state of the occupant with respect to the motion actuator 60 related to motion control of the vehicle 1.

The communication system 43 acquires communication data usable in the driving system 2 through wireless communication. The communication system 43 may receive a positioning signal from an artificial satellite of a global navigation satellite system (GNSS) present in the external environment of the vehicle 1. A communication device of a positioning type in the communication system 43 is, for example, a GNSS receiver.

The communication system 43 may transmit and receive communication signals to and from an external system (for example, a server 96) present in an external environment of the vehicle 1. A communication device of a V2X type in the communication system 43 is, for example, a dedicated short range communications (DSRC) communication device, or a cellular V2X (C-V2X) communication device. Examples of the communication with a V2X system present in the external environment of the vehicle 1 include communication with a communication system of another vehicle (V2V), communication with infrastructure such as a communication device set in a traffic light or a roadside device (V2I), communication with a mobile terminal of a pedestrian (V2P), communication with a network such as a cloud server (V2N), and the like. An architecture of the V2X communication, including the V2I communication, may adopt an architecture defined in ISO 21217, ETSI TS 102 940-943, IEEE 1609, or the like.

The communication system 43 may transmit and receive a communication signal to and from the internal environment of the vehicle 1, for example, with a mobile terminal 91 such as a smartphone present in the vehicle. A communication device of a terminal communication type in the communication system 43 is, for example, a Bluetooth (registered trademark) device, a Wi-Fi (registered trademark) device, or an infrared communication device.

The map DB 44 is a database for storing map data usable in the driving system 2. The map DB 44 includes at least one type of non-transitory tangible storage medium of, for example, a semiconductor memory, a magnetic medium, or an optical medium. The map DB 44 may include a database of a navigation unit that navigates a travel route of the vehicle 1 to a destination. The map DB 44 may include a database of a probe data (PD) map generated by using PD collected from each vehicle. The map DB 44 may include a database of a high definition map having a high level of definition mainly used for an automated driving system. The map DB 44 may include a database of a parking lot map including specific parking lot information, for example, parking space markings information, used for automated parking or parking support.

The map DB 44 appropriate to the driving system 2 acquires and stores the latest map data through, for example, communication with a map server via the communication system 43 of a V2X type. The map data is converted into two-dimensional or three-dimensional data as data indicating the external environment of the vehicle 1. The map data may include, for example, road data representing at least one type among positional coordinates, a shape, and a road surface condition of a road structure and a standard roadway. The map data may include marking data representing at least one type of, for example, a road sign, a road display, and a positional coordinate and a shape of a lane marking attached to a road. The marking data included in the map data may represent, for example, a traffic sign, an arrow marking, a lane marking, a stop line, a direction sign, a landmark beacon, a business sign, or a change in a line pattern of a road among target objects. The map data may include structure data representing at least one type of positional coordinates, a shape, and the like of a building and a traffic light facing the road, for example. The marking data included in the map data may represent, for example, a streetlight, a road edge, a reflecting plate, or a pole among the target objects.

The motion actuator 60 is capable of controlling a vehicle motion based on an input control signal. The motion actuator 60 of a driving type is a power train including, for example, at least one type among an internal combustion engine, a drive motor, and the like. The motion actuator 60 of a braking type is, for example, a brake actuator. The motion actuator 60 of a steering type is, for example, a steering.

Multiple human machine interface (HMI) devices 70 may be mounted in the vehicle 1. The HMI device 70 implements a human machine interaction, which is an interaction between an occupant (including a driver) of the vehicle 1 and the driving system 2. Some of the multiple HMI devices 70, which implement an operation input functionality for the occupant, may be a part of the sensing unit 10. Some of the multiple HMI devices 70, which implement an information presentation functionality, may be a part of the acting unit 30. Meanwhile, the functionality implemented by the HMI device 70 may be provided as a functionality independent of the sensing functionality, the planning functionality, and the acting functionality.

The HMI device 70 may be an operation input device capable of inputting an operation by a driver to transmit, to the driving system 2, the will or intention of the occupant of the vehicle 1 including the driver. The HMI device 70 of an operation input type is, for example, an accelerator pedal, a brake pedal, a shift lever, a steering wheel, a turn signal lever, a mechanical switch, and a touch panel of a navigation unit or the like. Among those, the accelerator pedal controls the power train serving as the motion actuator 60. The brake pedal controls the brake actuator serving as the motion actuator 60. The steering wheel controls a steering actuator serving as the motion actuator 60.

The HMI device 70 may be an information presentation device that presents information such as visual information, auditory information, and cutaneous sensory information to the occupant of the vehicle 1 including the driver. The HMI device 70 of a visual information presentation type is, for example, a combination meter, a graphic meter, the navigation unit, a center information display (CID), a head-up display (HUD), and an illumination unit. The HMI device 70 of an auditory information presentation type is, for example, a speaker and a buzzer. The HMI device 70 of a cutaneous sensory information presentation type is, for example, a vibration unit of the steering wheel, a vibration unit of a seat of the driver, a reaction force unit of the steering wheel, a reaction force unit of the accelerator pedal, a reaction force unit of the brake pedal, and an air conditioning unit.

The HMI device 70 may implement an HMI functionality in cooperation with a mobile terminal 91 such as a smartphone by communicating with the terminal through the communication system 43. For example, the HMI device 70 may present information acquired from the smartphone to the occupant including the driver. For example, an operation input of the smartphone may be used as an alternative to an operation input to the HMI device 70.

At least one processing system 50 is provided. For example, the processing system 50 may be an integrative processing system that executes a process related to the sensing functionality, a process related to the planning functionality, and a process related to the acting functionality in an integrated manner. In this case, the integrative processing system 50 may further execute a process related to the HMI device 70, and an HMI dedicated processing system may be separately provided. For example, the HMI dedicated processing system may be an integrated cockpit system that integrally executes a process related to each HMI device 70.

For example, the processing system 50 may include each of at least one processing unit corresponding to the process related to the sensing functionality, at least one processing unit corresponding to the process related to the planning functionality, and at least one processing unit corresponding to the process related to the acting functionality.

The processing system 50 includes a communication interface for an outside, and is connected to at least one type of elements related to the process performed by the processing system 50 among each sensor, the motion actuator 60, the HMI device 70, and the like via at least one type among, for example, a local area network (LAN), a wire harness, an internal bus, and a wireless communication circuit.

The processing system 50 includes at least one dedicated computer 51. The processing system 50 may combine multiple dedicated computers 51 to implement a functionality such as the sensing functionality, the planning functionality, and the acting functionality.

For example, the dedicated computer 51 constituting the processing system 50 may be an integrated ECU that integrates driving functionalities of the vehicle 1. The dedicated computer 51 constituting the processing system 50 may be a determination ECU that determines a DDT. The dedicated computer 51 constituting the processing system 50 may be a monitoring ECU that monitors driving of the vehicle 1. The dedicated computer 51 constituting the processing system 50 may be an evaluation ECU that evaluates driving of the vehicle 1. The dedicated computer 51 constituting the processing system 50 may be a navigation ECU that navigates a travel route of the vehicle 1.

The dedicated computer 51 constituting the processing system 50 may be a locator ECU that estimates a position of the vehicle 1. The dedicated computer 51 constituting the processing system 50 may be an image processing ECU that processes image data detected by the external environment sensor 41. The dedicated computer 51 constituting the processing system 50 may be an actuator ECU that controls the motion actuator 60 of the vehicle 1. The dedicated computer 51 constituting the processing system 50 may be an HMI control unit (HCU) that integrally controls the HMI devices 70. The dedicated computer 51 constituting the processing system 50 may be, for example, at least one external computer that is provided in an external center or a mobile terminal 91 that enables communication via the communication system 43.

The dedicated computer 51 constituting the processing system 50 includes at least one memory 51a and at least one processor 51b. The memory 51a may be, for example, at least one type of non-transitory tangible storage medium, such as a semiconductor memory, a magnetic medium, and an optical medium, which non-temporarily stores a computer program, data, and the like that can be read by the processor 51b. For example, a rewritable volatile storage medium such as a random access memory (RAM) may be provided as the memory 51a. The processor 51b includes, for example, at least one type of a central processing unit (CPU), a graphics processing unit (GPU), and a reduced instruction set computer (RISC)-CPU as a core.

The dedicated computer 51 constituting the processing system 50 may be a system on a chip (SoC) in which a memory 51a, a processor 51b, and an interface are integrally implemented on one chip, or at least one SoC may be provided as an element of the dedicated computer 51.

The processing system 50 may include at least one database for executing a dynamic driving task. The database may include, for example, a non-transitory tangible storage medium of at least one type of a semiconductor memory, a magnetic medium, and an optical medium, and an interface for accessing the storage medium.

The database may be a scenario database (hereinafter, referred to as “scenario DB”) 59. The database may be a rule database (hereinafter, rule DB) 58. At least one of the scenario DB 59 and the rule DB 58 may not be provided in the processing system 50, but may be provided independently in the driving system 2. At least one of the scenario DB 59 and the rule DB 58 may be provided in an external system present in an external environment and configured to be accessible from the processing system 50 via the communication system 43.

The scenario DB 59 has a scenario catalog in which multiple scenarios used for driving the vehicle 1 are stored. The driving system 2 can, for example, apply the situation in which the vehicle 1 is located to one scenario selected from multiple scenarios or a combination of multiple scenarios. The scenario DB 59 may store multiple scenarios including at least one of a functional scenario, a logical scenario, and a concrete scenario. The functional scenario defines a top-level qualitative scenario structure. The logical scenario is a scenario obtained by assigning a quantitative parameter range to a structured functional scenario. The concrete scenario defines a boundary of a safety determination for distinguishing between a safe state and an unsafe state.

The rule DB 58 stores a rule set used for driving the vehicle 1. The rule set may include multiple rules. The rule set may further include a structure of the degree of priority for a series of rules, which is set based on a relative importance among the multiple rules. The rule set may be an implementation of guidelines for strategic driving of the vehicle 1.

The multiple rules may include rules based on laws, regulations, and a combination thereof. The multiple rules may include rules based on a preference that is not influenced by the laws, the regulations, or the like. The multiple rules may include rules based on a motion behavior based on an experience in the past. The multiple rules may include rules based on a characterization of a motion environment. The multiple rules may include rules based on ethical concerns. The multiple rules may include rules based on a basic principle of a safety model to be described below (for example, the five principles of an RSS model). The plurality of rules may include a traffic rule. The traffic rule may be a rule defined in the Road Traffic Law, or may be a rule based on national or regional customs.

The rules such as the traffic rules stored in the rule DB 58 may be positioned as the information provided from the sensing unit 10 to the planning unit 20 by the sensing functionality, similarly to the map information acquired from the map DB 44.

The processing system 50 may also include at least one recording device 55 that records at least one of the sensing information, planning information, and action information of the driving system 2. The recording device 55 may include at least one large-capacity storage medium 55c. The storage medium 55c may be at least one type of non-transitory tangible storage medium among, for example, a semiconductor memory, a magnetic medium, and an optical medium.

The storage medium 55c may be mounted on a substrate in a form that is not easily detachable or replaceable, and in this form, for example, an embedded Multi Media Card (eMMC) or the like using a flash memory may be adopted. At least one of the storage media 55c may be in a form that is detachable and replaceable with respect to the recording device 55, and in this form, for example, an SD card or the like may be adopted.

The recording device 55 may have a functionality of selecting information to be recorded from among the sensing information, the planning information, and the action information. In this case, the recording device 55 may include a dedicated computer.

The dedicated computer provided in the recording device 55 has at least one memory 55a and at least one processor 55b. The memory 55a may be, for example, at least one type of non-transitory tangible storage medium, such as a semiconductor memory, a magnetic medium, and an optical medium, which non-temporarily stores a computer program, data, and the like that can be read by the processor 55b. For example, a rewritable volatile storage medium such as a random access memory (RAM) may be provided as the memory 55a. The processor 55b includes, for example, at least one type of a central processing unit (CPU), a graphics processing unit (GPU), and a reduced instruction set computer (RISC)-CPU as a core.

The dedicated computer may be a system on a chip (SoC) in which the memory 55a, the processor 55b, and an interface are integrally implemented on one chip, or at least one SoC may be provided as an element of the dedicated computer.

The recording device 55 may access the storage medium 55c, and execute recording in accordance with a data write command from each unit of the driving system 2. The recording device 55 may determine information transmitted to the in-vehicle network, access the storage medium 55c, and execute recording based on determination of the processor 55b provided in the recording device 55.

The recording device 55 may not be provided in the processing system 50 but may be provided independently in the driving system 2. The recording device 55 may be provided in the external system present in the external environment, and configured to be accessible from the processing system 50 via the communication system 43.

The processing system 50 may include at least one risk checker 53.

The risk checker 53 may be one aspect of on-board implementation of responsibility sensitive safety (RSS) as a safety model. The risk checker 53 may be an on-board checker for the planning functionality implemented by the dedicated computer 51. The risk checker 53 implements, by hardware independent of the planning unit 20, the risk checking unit 26 that implements the risk checking functionality.

The risk checker 53 may be configured mainly with a dedicated computer having at least one memory 53a and at least one processor 53b. The memory 55a may be, for example, at least one type of non-transitory tangible storage medium, such as a semiconductor memory, a magnetic medium, and an optical medium, which non-temporarily stores a computer program, data, and the like that can be read by the processor 55b. For example, a rewritable volatile storage medium such as a random access memory (RAM) may be provided as the memory 55a. The processor 55b includes, for example, at least one type of a central processing unit (CPU), a graphics processing unit (GPU), and a reduced instruction set computer (RISC)-CPU as a core.

The dedicated computer may be a system on a chip (SoC) in which the memory 53a, the processor 53b, and an interface are integrally implemented on one chip, or at least one SoC may be provided as an element of the dedicated computer.

### (Logical Architecture Overview)

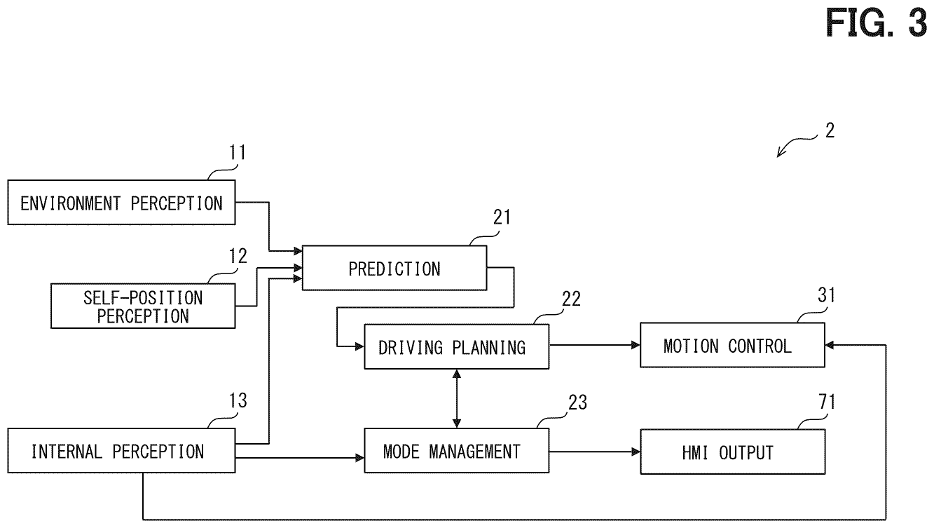

Next, an example of a logical architecture of the driving system 2 will be described with reference to FIG. 3. The sensing unit 10 may include an environment perception unit 11, a self-position perception unit 12, and an internal perception unit 13 as processing units for implementing, by executing a computer program by the processor, sub-functionalities obtained by further classifying the sensing functionalities.

The environment perception unit 11 individually processes information (referred to as sensor data in some cases) on an external environment acquired from each sensor 40 and implements a functionality of perceiving the external environment including a target object, other road users, and the like. The environment perception unit 11 processes detection data detected by each external environment sensor 41 individually. The detection data may be detection data provided from, for example, a millimeter wave radar, a sonar, or a LiDAR. The environment perception unit 11 may generate relative position data including a direction, a size, and a distance of an object with respect to the vehicle 1, from raw data detected by the external environment sensor 41.

The detection data may be image data provided from, for example, a camera or a LIDAR. The environment perception unit 11 processes the image data, and extracts an object that is reflected in an angle of view of the image. The extraction of the object may include estimation of the direction, the size, and the distance of the object with respect to the vehicle 1. The extraction of the object may include, for example, classification of the object by using semantic segmentation.

The environment perception unit 11 processes information acquired through a V2X functionality of the communication system 43. The environment perception unit 11 processes information acquired from the map DB 44.

The environment perception unit 11 may be further classified into multiple sensor perception units each optimized for one sensor group. The sensor perception unit may fuse information of one sensor group when the sensor perception unit is associated to perceive information of the one sensor group.

The self-position perception unit 12 conducts localization of the vehicle 1. The self-position perception unit 12 acquires global position data of the vehicle 1 from the communication system 43 (for example, a GNSS receiver). In addition, the self-position perception unit 12 may acquire position information on the target object extracted by the environment perception unit 11. The self-position perception unit 12 acquires map information from the map DB 44. The self-position perception unit 12 integrates these pieces of information to estimate a position of the vehicle 1 on a map.

The internal perception unit 13 implements a functionality of perceiving a vehicle state by processing detection data detected by each internal environment sensor 42. The vehicle state may include a state of a motion physical quantity of the vehicle 1 detected by a velocity sensor, an acceleration sensor, a gyro sensor, or the like. The vehicle state may include at least one type of a state of an occupant including a driver, an operation state of the driver with respect to the motion actuator 60, and a switching state of the HMI devices 70.

The planning unit 20 may include a prediction unit 21, a driving planning unit 22, and a mode management unit 23 as processing units for implementing, by executing a computer program by the processor, sub-functionalities obtained by further classifying the planning functionalities.

The prediction unit 21 acquires external environment information perceived by the environment perception unit 11 and the self-position perception unit 12, the vehicle state perceived by the internal perception unit 13, and the like. The prediction unit 21 may interpret an environment based on the acquired information, and estimate the current situation in which the vehicle 1 is located. The situation here may be an operational situation, or may include an operational situation.

The prediction unit 21 may interpret the environment and predict actions of objects such as other road users. The object here may be a safety-relevant object. The prediction of the action here may include at least one of prediction of a velocity of the object, prediction of an acceleration of the object, and prediction of a trajectory of the object. The prediction of the act may be executed based on a reasonably foreseeable assumption. The prediction unit 21 may estimate an intention of the driver, based on the predicted action, the predicted potential hazard, and the acquired vehicle state.

The driving planning unit 22 plans automated driving of the vehicle 1, based on at least one type of estimation information of the position of the vehicle 1 on the map provided by the self-position perception unit 12, prediction information and driver intention estimation information provided by the prediction unit 21, functional constraint information provided by the mode management unit 23, and the like.

The driving planning unit 22 implements a route planning functionality, a behavior planning functionality, and a trajectory planning functionality. The route planning functionality is a functionality of planning at least one of a route to a destination and a lane plan at a middle distance based on the estimation information of the position of the vehicle 1 on the map. The route planning functionality may further include a functionality of determining at least one request of a lane changing request and a deceleration request, based on the lane plan at the middle distance. The route planning functionality may be a mission/route planning functionality in a strategic functionality, or may be a functionality of outputting a mission plan and a route plan.

The behavior planning functionality is a functionality of planning a behavior of the vehicle 1, based on at least one of the route to the destination and the lane plan at the middle distance planned by the route planning functionality, the lane changing request and the deceleration request, the prediction information and the driver intention estimation information provided by the prediction unit 21, and the functional constraint information provided by the mode management unit 23. The behavior planning functionality may include a functionality of generating a condition related to a state transition of the vehicle 1. The condition related to the state transition of the vehicle 1 may correspond to a triggering condition. The behavior planning functionality may include a functionality of determining a state transition of an application that implements a DDT, and further include a functionality of determining a state transition of a driving action, based on the condition. The behavior planning functionality may include a functionality of determining a constraint related to a path of the vehicle 1 in a longitudinal direction and a constraint related to the path of the vehicle 1 in a lateral direction, based on information on these state transitions. The behavior planning functionality may be a strategic behavior plan in a DDT functionality, or may output a strategic behavior.

The trajectory planning functionality is a functionality of planning a travel trajectory of the vehicle 1, based on the determination information provided by the prediction unit 21, the constraint related to the path of the vehicle 1 in the longitudinal direction, and the constraint related to the path of the vehicle 1 in the lateral direction. The trajectory planning functionality may include a functionality of generating a path plan. The path plan may include a velocity plan, or the velocity plan may be generated as a plan independent of the path plan. The trajectory planning functionality may include a functionality of generating multiple path plans and selecting an optimal path plan from the multiple path plans, or a functionality of switching between the path plans. The trajectory planning functionality may further include a functionality of generating backup data of the generated path plan. The trajectory planning functionality may be a trajectory planning functionality in the DDT functionality, or may output a trajectory plan.

The mode management unit 23 monitors the driving system 2, and sets a functional constraint related to driving. The mode management unit 23 may manage a mode of automated driving, for example, a state of the automated driving level. The management of the automated driving level may include switching between manual driving and automated driving, that is, authority transfer between the driver and the driving system 2, in other words, management of takeover. The mode management unit 23 may monitor a state of a subsystem related to the driving system 2, and determine a defect of the system (for example, an error, an unstable operation state, a system failure, or a failure). The mode management unit 23 may determine a mode based on the intention of the driver, based on the driver intention estimation information generated by the internal perception unit 13. The mode management unit 23 may set a functional constraint related to driving, based on at least one of a determination result of the defect of the system, a determination result of the mode, and further, the vehicle state provided by the internal perception unit 13, a sensor abnormality (or sensor failure) signal output from the sensor 40, state transition information of the application and the trajectory plan provided by the driving planning unit 22, and the like.

The mode management unit 23 may have a functionality of determining the constraint related to the path of the vehicle 1 in the longitudinal direction and the constraint related to the path of the vehicle 1 in the lateral direction in an integrated manner, in addition to the functional constraint related to driving. In this case, the driving planning unit 22 plans a behavior and plans a trajectory, in accordance with the constraint determined by the mode management unit 23.

When the risk checking unit 26 is implemented independently of the planning unit 20, a situation extraction unit 27, a situation checking unit 28, a response unit 29, and the like to be described below may be provided separately from the prediction unit 21, the driving planning unit 22, and the mode management unit 23 in FIG. 3. When the risk checking unit 26 is implemented as a part of the planning unit 20, the risk checking functionality of the risk checking unit 26 may be implemented as a part of the functionalities implemented by the prediction unit 21, the driving planning unit 22, and the mode management unit 23.

The acting unit 30 may include a motion control unit 31 and an HMI output unit 71 as processing units for implementing, by executing a computer program by the processor, sub-functionalities obtained by further classifying the action functionalities. The motion control unit 31 controls a motion of the vehicle 1, based on the trajectory plan (for example, the path plan and the velocity plan) acquired from the driving planning unit 22. Specifically, the motion control unit 31 generates accelerator request information, shift request information, brake request information, and steering request information corresponding to the trajectory plan, and outputs the accelerator request information, the shift request information, the brake request information, and the steering request information to the motion actuator 60.

The motion control unit 31 is capable of directly acquiring the vehicle state, for example, at least one of a current velocity, a current acceleration, and a current yaw rate of the vehicle 1, perceived by the sensing unit 10 (particularly, the internal perception unit 13) from the sensing unit 10, and reflecting the vehicle state on the motion control of the vehicle 1.

The HMI output unit 71 outputs information on an HMI, based on at least one of the prediction information and the driver intention estimation information provided by the prediction unit 21, the state transition information of the application and the trajectory plan provided by the driving planning unit 22, the functional constraint information provided by the mode management unit 23, and the like. The HMI output unit 71 may manage a vehicle interaction. The HMI output unit 71 may generate a notification request based on a management state of the vehicle interaction, and control an information presentation functionality of the HMI devices 70. The HMI output unit 71 may generate a control request for a wiper, a sensor cleaning device, a headlight, and an air conditioner based on the management state of the vehicle interaction, and control these devices.

### (Safety Model and Implementation Thereof)

The driving system 2 may implement a safety model of automated driving. The safety model is a model for demonstrating that there is no acceptable risk in a specific operational design domain. The safety model may correspond to, for example, a safety driving model, a safety-related model, or a formal model. As the safety model, for example, the RSS model may be adopted, and another model, a more generalized model, or a complex model obtained by combining multiple models may also be adopted.

For example, in the RSS model, five rules (five principles) are adopted. The first rule is “Do not hit someone from behind”. The second rule is “Do not cut-in recklessly”. The third rule is “Right-of-way is given, not taken”. The fourth rule is, “Be careful of area another one, you must do it”. The fifth rule is “If you can avoid an accident without causing another one, you must do it”.

Based on the five rules, particularly the first and second rules, a safety envelope may be defined. For example, the safety envelope may mean a longitudinal safety distance and a lateral safety distance with respect to other road users or may mean a condition or a concept for calculating these safety distances. The safety distance is an example of a geometric approach.

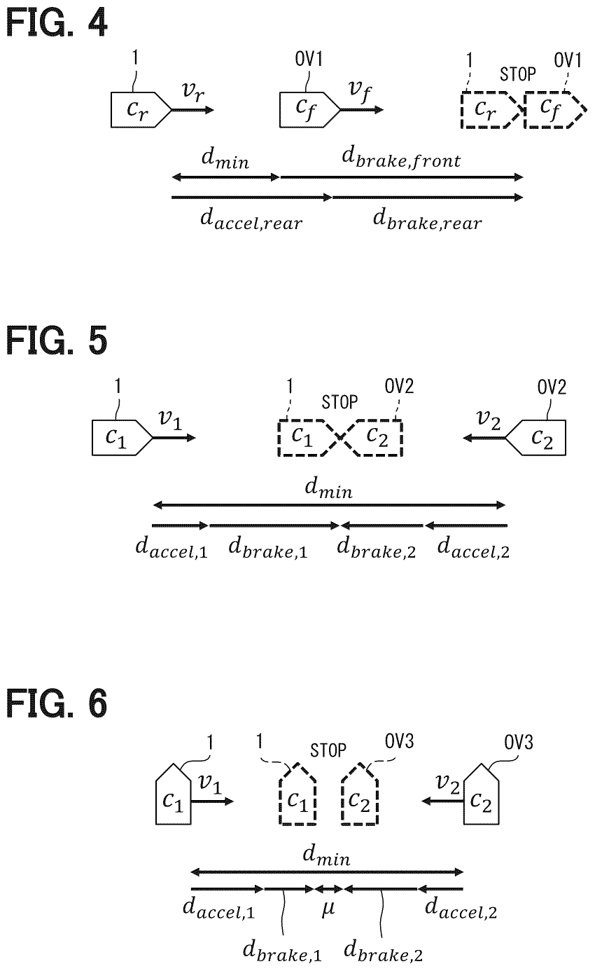

A longitudinal safety distance dₘᵢₙ may be a distance at which a rear-end collision does not occur when a preceding vehicle OV1, traveling at a velocity v_{f}, brakes at a maximum deceleration a_{max, brake} and stops, even when a rear vehicle (for example, vehicle 1) accelerates with a response time ρ and a maximum acceleration a_{max, accel}, and then brakes at a minimum deceleration a_{min, brake} and stops, as illustrated in FIG. 4.

Here, the stopping distance d_{brake, front} of the preceding vehicle OV1 is expressed by the following expression 1.

$${d}_{brake , front} = \frac{{v}_{f}^{2}}{2 {a}_{max , brake}} \qquad [ Formula 1 ]$$

The reaction distance d_{reaction, rear} of the rear vehicle (vehicle 1) is expressed by the following expression 2.

$${d}_{reaction , rear} = {v}_{r} ρ + \frac{1}{2} {a}_{max , accel} {ρ}^{2} \qquad [ Formula 2 ]$$

The braking distance d_{brake, rear} of the rear vehicle (vehicle 1) is expressed by the following Formula 3.

$${d}_{brake , rear} = \frac{{( {v}_{r} + {a}_{max , accel} ρ )}^{2}}{2 {a}_{min , brake}} \qquad [ Formula 3 ]$$

The safety distance dₘᵢₙ is expressed by the expression shown in the following Formula 4 as a value obtained by adding the braking distance of the rear vehicle to the reaction distance of the rear vehicle and subtracting the stopping distance of the preceding vehicle OV1.

$${d}_{min} = {d}_{reaction , rear} + {d}_{brake , rear} - {d}_{b r a k e , f ront} \qquad [ Formula 4 ]$$

The longitudinal safety distance dₘᵢₙ may be a distance at which a head-on collision does not occur even when two vehicles, the vehicle 1 and a vehicle OV2 are traveling toward each other at their respective velocities v₁ and v₂, accelerate with the predetermined response time ρ and the maximum acceleration a_{max, accel}, and then brake and stop at the minimum deceleration a_{min, brake}, as illustrated in FIG. 5.

Here, the reaction distance d_{reaction, 1} of the vehicle 1 is expressed by the expression shown in the following Formula 5.

$${d}_{reaction , 1} = {v}_{1} ρ + \frac{1}{2} {a}_{max , accel} {ρ}^{2} \qquad [ Formula 5 ]$$

The braking distance d_{brake, 1} of the vehicle 1 is expressed by the expression shown in the following Formula 6.

$${d}_{brake , 1} = \frac{{( {v}_{1} + {a}_{max , accel} ρ )}^{2}}{2 {a}_{min , brake}} \qquad [ Formula 6 ]$$

The reaction distance d_{reaction, 2} of the vehicle OV2 is expressed by the expression shown in the following Formula 7.

$${d}_{reaction , 2} = {v}_{2} ρ + \frac{1}{2} {a}_{max , accel} {ρ}^{2} \qquad [ Formula 7 ]$$

The braking distance d_{brake, 2} of the vehicle OV2 is expressed by the expression shown in the following Formula 8.

$${d}_{brake , 2} = \frac{{( {v}_{2} + {a}_{max , accel} ρ )}^{2}}{2 {a}_{min , brake}} \qquad [ Formula 8 ]$$

The safety distance dₘᵢₙ is expressed by the expression shown in the following Formula 9 as a sum of the reaction distance of the vehicle 1, the braking distance of the vehicle 1, the reaction distance of the vehicle OV2, and the braking distance of the vehicle OV2.

$${d}_{min} = {d}_{r eaction , 1} + {d}_{brake , 1} + {d}_{r eaction , 2} + {d}_{brake , 2} \qquad [ Formula 9 ]$$

The lateral safety distance dₘᵢₙ may be a distance at which a minimum distance μ is secured and a collision does not occur even when two vehicles, the vehicle 1 and a vehicle OV3 are traveling side by side at the lateral velocities v₁ and v₂, respectively, accelerate at the predetermined response time ρ and the maximum acceleration a_{max, accel}, and then decelerate in the lateral direction at the maximum deceleration a_{max, brake}, as illustrated in FIG. 6.

Here, the reaction distance d_{reaction, 1} of the vehicle 1 is represented by the expression shown in the following Formula 10.

$${d}_{reaction , 1} = {v}_{1} ρ + \frac{1}{2} {a}_{max , accel} {ρ}^{2} \qquad [ Formula 10 ]$$

The braking distance d_{brake, 1} of the vehicle 1 is expressed by the expression shown in the following Formula 11.

$${d}_{brake , 1} = \frac{{( {v}_{1} + {a}_{max , accel} ρ )}^{2}}{2 {a}_{min , brake}} \qquad [ Formula 11 ]$$

The reaction distance d_{reaction, 2} of the vehicle OV3 is represented by the expression shown in the following Formula 12.

$${d}_{reaction , 2} = {v}_{2} ρ + \frac{1}{2} {a}_{max , accel} {ρ}^{2} \qquad [ Formula 12 ]$$

The braking distance d_{brake, 2} of the vehicle OV3 is represented by the expression shown in the following Formula 13.

$${d}_{brake , 2} = \frac{{( {v}_{2} + {a}_{max , accel} ρ )}^{2}}{2 {a}_{min , brake}} \qquad [ Formula 13 ]$$

The safety distance dₘᵢₙ is expressed by the expression shown in the following Formula 14 as a sum of the reaction distance of the vehicle 1, the braking distance of the vehicle 1, the reaction distance of the vehicle OV3, and the braking distance of the vehicle OV3.

$${d}_{min} = {d}_{reaction , 1} + {d}_{brake , 1} + {d}_{reaction , 2} + {d}_{brake , 2} \qquad [ Formula 14 ]$$

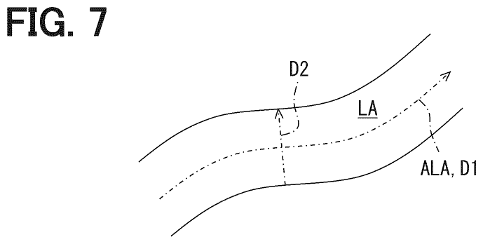

A coordinate system used in the safety model may be a lane-based coordinate system. As illustrated in FIG. 7, this coordinate system processes movement of the vehicle 1 in a direction along a lane LA by defining a center line of the lane LA, that is, a lane axis ALA along a curve of a road. On the other hand, in order to define a longitudinal axis and a lateral axis of each road user, a road-user-based coordinate system may be used. This coordinate system is based on a center of gravity of the road user and defines an ordinate and an abscissa depending on a heading angle of the road user.

For example, as illustrated in FIG. 1, the risk checking unit 26 implemented in the driving system 2 is arranged in parallel with the planning unit 20 and executes a calculation process. Specifically, the risk checking unit 26 acquires an environment model, sensor data, or the like from the sensing unit 10, evaluates a risk based on these pieces of information, and outputs a response according to the risk to the acting unit 30. This series of functionalities or processes may be referred to as risk checking or risk monitoring. The risk checking unit 26 may include the situation extraction unit 27, the situation checking unit 28, and the response unit 29 as sub-blocks obtained by further classifying the functionalities.

The situation extraction unit 27 extracts a situation based on information acquired from the sensing unit 10. Data indicating the situation (hereinafter, situation data) may include a list of objects present in the vicinity of the vehicle 1 (hereinafter, surrounding objects). The surrounding objects may include other road users. The situation data may include data indicative of a potential conflict between the vehicle 1 and the surrounding object. In this case, the situation data may include a probability of the presence, and an uncertainty of a position, an orientation, and a velocity of the vehicle 1 and the surrounding object. The situation extraction unit 27 may extract multiple situations. The situation may be a traffic situation. The situation may be selected from a series of considered situations.

The situation checking unit 28 checks whether the situation extracted by the situation extraction unit 27 is a safe situation or a hazardous situation. The situation checking unit 28 executes at least one of checking by the geometric approach described above and checking by using another methodology. The checking here may be referred to as checking of a risk. When the checking of the risk is executed, a safety envelope may refer to an acceptable collision risk.

The checking of the risk may include checking of an estimated result of the collision risk between the vehicle 1 and the surrounding object. The collision risk may include a collision risk over time, and may include a peak collision risk. The collision risk may be a probability of collision. That is, an uncertainty can be taken into account in the checking of the risk.

When the safety envelope is violated, the situation checking unit 28 determines that a situation as a checking target is a hazardous situation. When the situation checking unit 28 executes checking of the risk, the situation checking unit 28 may compare the estimated collision risk value with a threshold of an acceptable collision risk. When the estimated collision risk value is below the threshold of the acceptable collision risk, the situation checking unit 28 may determine that the situation as a checking target is a safe situation. When the estimated collision risk value exceeds the threshold of the acceptable collision risk, the situation checking unit 28 may determine that the situation as a checking target is a hazardous situation. That is, when there is no violation of the safety envelope, the situation checking unit 28 determines that the situation as a checking target is a safe situation. This risk threshold may be, for example, a longitudinal safety distance and a lateral safety distance.

The situation checking unit 28 may set a hypothesis on the surrounding object, and check a risk based on the hypothesis. In this case, multiple hypotheses may be used. The hypothesis may be or may include an assumption on a reasonably foreseeable behavior. The hypothesis may be a prediction derived based on this assumption, and may include the prediction derived based on this assumption.

That is, there is a possibility that an assumed kinematic value is influenced by an acceptable risk level. The acceptable risk level or risk threshold may be set in advance based on a risk acceptance criteria/criterion. The quantitative criterion of the risk acceptance criteria/criterion is, for example, a probability of occurrence of harm falling below a threshold. The risk acceptance criteria/criterion may be set based on a positive risk balance, which is a main measure of a risk level that is ethically acceptable. The risk acceptance criteria/criterion may be set by, for example, a combination of a statistical approach such as traffic accident statistics and an approach based on a scenario.

The risk acceptance criteria/criterion may be determined based on a comparison between the driving system 2 under a reasonably foreseeable scenario of the ODD and an experienced and attentive driver. For example, the risk acceptance criteria/criterion may be set based on the fact that the capability of the driving system 2 is equal to or higher than the driving ability of an experienced and attentive driver.

The acceptable risk level or the risk threshold may be designated in advance by at least one of, for example, a government agency, a standardization agency, and an approval agency of the driving system 2. The acceptable risk level or the risk threshold may be set in advance by, for example, a developer of the driving system 2.

The driving system 2 or the risk checking unit 26 may be designed to change the risk threshold according to the ODD. The driving system 2 or the risk checking unit 26 may be designed to change the risk threshold according to the use case.

The situation checking unit 28 may refer to a rule set stored in the rule DB 58 to determine the acceptable risk level. The situation checking unit 28 may improve estimation accuracy by incorporating the rules of the rule set into an algorithm for calculating the risk value.

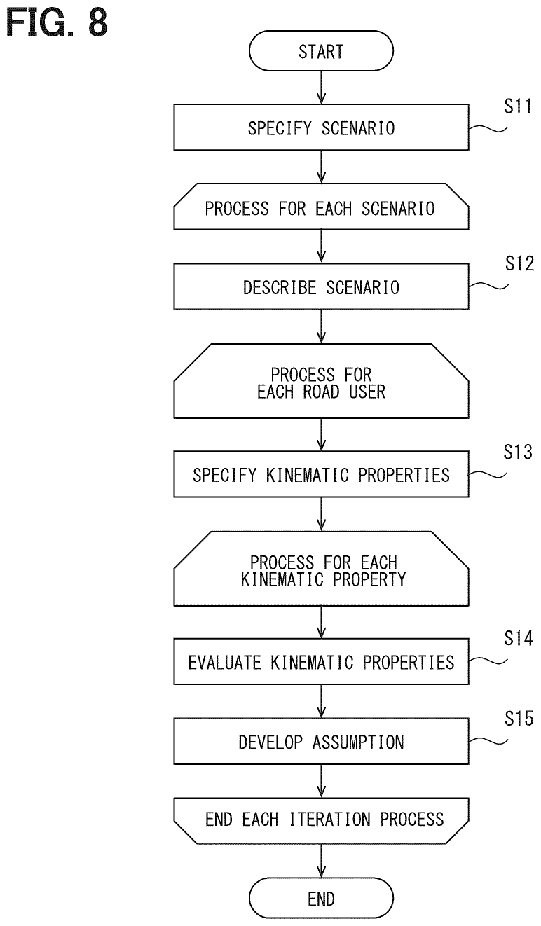

FIG. 8 illustrates an example of a processing method for deriving and defining an assumption. The process may be implemented, for example, by executing a computer program stored in the memory 53a by the processor 53b of the risk checker 53. A series of processes in steps S11 to S15 is executed for each predetermined regular time interval or based on a predetermined trigger. The predetermined trigger may be provided as, for example, the latest situation data being provided from the situation extraction unit 27 to the situation checking unit 28. This process may be used not during actual traveling of the vehicle 1 but in conduction of V&V on the driving system 2 by simulation or the like.

In the first step S11, a scenario currently being encountered by the vehicle 1 is specified. The specifying of the scenario may include selecting a scenario from, for example, a catalog of scenarios stored in the scenario DB 59. One scenario may be selected. Multiple scenarios may be selected. A more complex situation may be represented by combining the multiple scenarios. After the process in S11, the process proceeds to S12.

S12 to S15 are iteration processes for each scenario. In S12, a relevant scene and a road user as dynamic elements are specified and highly described. After the process in S12, the process proceeds to S13.

S14 and S15 are iteration processes for each kinematic property. In S14, whether the kinematic properties are safety relevant is evaluated based on the scenario specified in S11. This evaluation is conducted by checking whether a certain property is a motion of other road users and may cause a motion for the vehicle 1. When the kinematic property is not relevant to a safety, the kinematic property is excluded from application to the scenario specified in S11. After the process in S14, the process proceeds to S15.

In S15, an assumption on a reasonably foreseeable behavior of other road users for the scenario specified in S11 is created. The assumption can be defined by setting a boundary for the range of behaviors of other road users that are reasonably foreseeable in a specific travel situation. After the process in S15, the process is returned to S12, S13, and S14 and repeated, depending on the remaining processing state of other scenarios, road users, and kinematic properties. When the process is completed for all the scenarios, the series of processes is ended.

The assumption may be a function of a time which is changed during a specified scenario. Alternatively, the assumption may not be changed during the specified scenario. A minimum set of the assumption on other road users may be defined.

The minimum set may include one or more properties according to a scenario, among a reasonably foreseeable maximum assumed longitudinal velocity other road users could exhibit, a reasonably foreseeable maximum assumed lateral velocity other road users could exhibit, a reasonably foreseeable maximum assumed longitudinal acceleration other road users preceding the vehicle could exhibit, a reasonably foreseeable maximum assumed lateral acceleration other road users could exhibit, a reasonably foreseeable maximum assumed longitudinal deceleration other road users preceding the vehicle could exhibit, a reasonably foreseeable minimum assumed longitudinal deceleration other road users traveling in an opposite direction to the vehicle or following the vehicle could exhibit, a reasonably foreseeable minimum assumed lateral deceleration other road users could exhibit, a reasonably foreseeable maximum assumed heading angle other road users could exhibit, a reasonably foreseeable maximum assumed heading angle rate change other road users could exhibit, a reasonably foreseeable maximum assumed lateral position fluctuation other road users could exhibit, and a reasonably foreseeable maximum assumed response time other road users could exhibit.

The values of these assumptions may differ depending on the category of the road users. For example, an assumption value may be changed depending on whether the road user is a vulnerable road user (VRU). The assumption value may be adjusted depending on at least one of various road surface conditions and weather-related environmental conditions that are reasonably expected within an operational design domain. The assumption value may also be adjusted according to at least one of a difference in road traffic laws across countries and a difference in traffic customs across regions.

The response unit 29 derives a proper response based on the checking result of the situation checking unit 28. The proper response may be provided to the acting unit 30 only when the situation is determined to be a hazardous situation. The proper response may be a restriction of a control command of the motion actuator 60. The proper response may be a response to return the vehicle 1 to a safe state. Even when multiple unrelated hazardous situations are checked, the acts to be taken by the vehicle 1 need to be integrated into one act. Therefore, in this case, the response unit 29 resolves a potential conflict between the proper responses for these situations, and transmits the proper response to the acting unit 30.

The risk checking unit 26 can output at least one of data indicating a situation, a checking result of the situation, and a derived proper response. The risk checking unit 26 may sequentially store at least one of the data indicating the situation, the checking result of the situation, and the derived proper response in the storage medium 55c, by using the recording device 55 or the like. The risk checking unit 26 may transmit at least one of the data indicating the situation, the checking result of the situation, and the derived proper response to an external system (for example, the server 96) using the communication system 43, and store the data indicating the situation, the checking result of the situation, and the derived proper response in a database (for example, the management DB 96c) of the server 96.

The risk checking unit 26 may execute an output in a prioritized manner to maintain duty of care for other road users. The risk checking unit 26 may support an operation in an emergency. The operation in an emergency may be a DDT fallback. The operation in an emergency may be executed when, despite a proper response to a potentially hazardous situation, the hazardous situation actually occurs and the risk is not sufficiently reduced.

The risk checking unit 26 may distinguish between an initiator of a hazardous scenario and a responder of a hazardous scenario. The risk checking unit 26 may distinguish between an action recommended for the initiator and an action recommended for the responder. That is, when the vehicle 1 is the initiator, the risk checking unit 26 derives a proper response according to the action recommended for the initiator, and when the vehicle 1 is the responder, the risk checking unit 26 derives a proper response according to the action recommended for the responder.

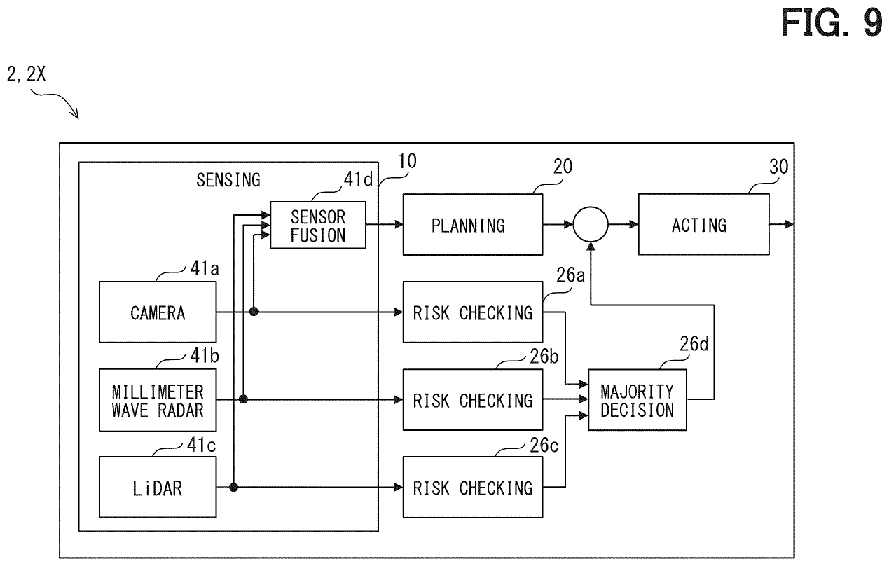

Multiple risk checking units 26 may be provided to constitute a redundant system. As a specific example of constituting a redundant system, an example of a driving system 2X based on a three-redundant majority decision in which multiple risk checking units 26a, 26b, and 26c illustrated in FIG. 9 are provided will be described below. In the driving system 2X illustrated in FIG. 9, the sensing unit 10 includes, as the multiple external environment sensors 41, three types of sensors including at least one camera 41a, at least one millimeter wave radar 41b, and at least one LIDAR 41c. The sensing unit 10 includes a sensor fusion unit 41d that fuses sensing results of the camera 41a, the millimeter wave radar 41b, and the LiDAR 41c. The perception results of the external environment generated by fusing the sensing results in the sensor fusion unit 41d are output to the planning unit 20.

The multiple risk checking units that are risk checking units 26a, 26b, and 26c are arranged in parallel with the planning unit 20 as in FIG. 1. The multiple risk checking units that are risk checking units 26a, 26b, and 26c are also arranged in parallel with one another. A total of three risk checking units, the risk checking units 26a, 26b, and 26c in FIG. 9, are provided so as to be paired with corresponding sensors of different types. In this configuration, in order to ensure hardware redundancy, it is preferable that the planning unit 20, the risk checking unit 26a, the risk checking unit 26b, and the risk checking unit 26c are implemented by hardware (for example, separate computers or SoCs) independent of one another.

The sensing result of the camera 41a is output to the risk checking unit 26a. The sensing result of the millimeter wave radar 41b is output to the risk checking unit 26b. The sensing result of the LiDAR 41c is output to the risk checking unit 26c.

With the information transmission route described above, the planning unit 20 executes a process related to the planning functionality based on the information after fusion by the multiple types of external environment sensors 41. On the other hand, the risk checking unit 26a executes a process related to checking of the risk based on the sensing result of the camera 41a. The risk checking unit 26b executes a process related to checking of a risk based on a sensing result of the millimeter wave radar 41b. The risk checking unit 26c executes a process related to checking of a risk based on a sensing result of the LiDAR 41c. Each of the risk checking units 26a, 26b, and 26c has the same functionality as the risk checking unit 26 described above. On the other hand, each of the risk checking units 26a, 26b, and 26c may be customized (optimized) based on a difference in input.

The checking results of the risk by the risk checking units 26a, 26b, and 26c are aggregated by majority decision performed by the majority decision unit 26d. The aggregated checking results of the risk interfere with an action plan output from the planning unit 20 to the acting unit 30. For example, a route plan, a behavior plan, and a trajectory plan by the planning unit 20 may be corrected or rewritten by a proper response output as the aggregated checking results of the risk.

In addition to the sensing result of the external environment sensor 41, at least one of the information acquired through the V2X functionality, the map information acquired from the map DB 44, and the rules such as the traffic rule acquired from the rule DB may be provided from the sensing unit 10 to the planning unit 20. These may or may not be provided to the risk checking units 26a, 26b, and 26c.

### (V&V Process and Implementation Thereof)

In V&V of the driving system 2, there are verification for satisfying a safety requirement of each technical level and verification for safe integration of elements. The verification for satisfying the safety requirement of each technical level may include evaluation of at least one of the following functionalities and capabilities, preferably all of the functionalities and capabilities. The verification may include evaluation of other functionalities and capabilities.

For example, an evaluation target for the sensing unit 10 is a functionality of the sensor 40 or an external data source (for example, a map data source), a functionality of a sensor algorithm that models an environment, and reliability of the infrastructure and the communication system 43.

For example, the evaluation target related to the planning unit 20 is the capability of the determination algorithm. The capability of the determination algorithm is, for example, a capability of safely handling a potential lack of functionality, and a capability of making a proper determination according to an environment model, a driving policy, a current destination, and the like. For example, the evaluation targets related to the planning unit 20 include one of the absence of unreasonable risks due to hazardous behaviors of the intended functionality, the functionality of the system to safely handle ODD use cases, a robust performance of execution of the entire ODD driving policy, suitability for DDT fallback, and suitability for minimal risk conditions.

For example, the evaluation target may include robust performance of a system or a functionality. The robust performance of the system or the functionality is a robust performance of a system under adverse environmental conditions, suitability of a system operation under known triggering conditions, sensitivity of an intended functionality, an ability to monitor various scenarios, or the like.

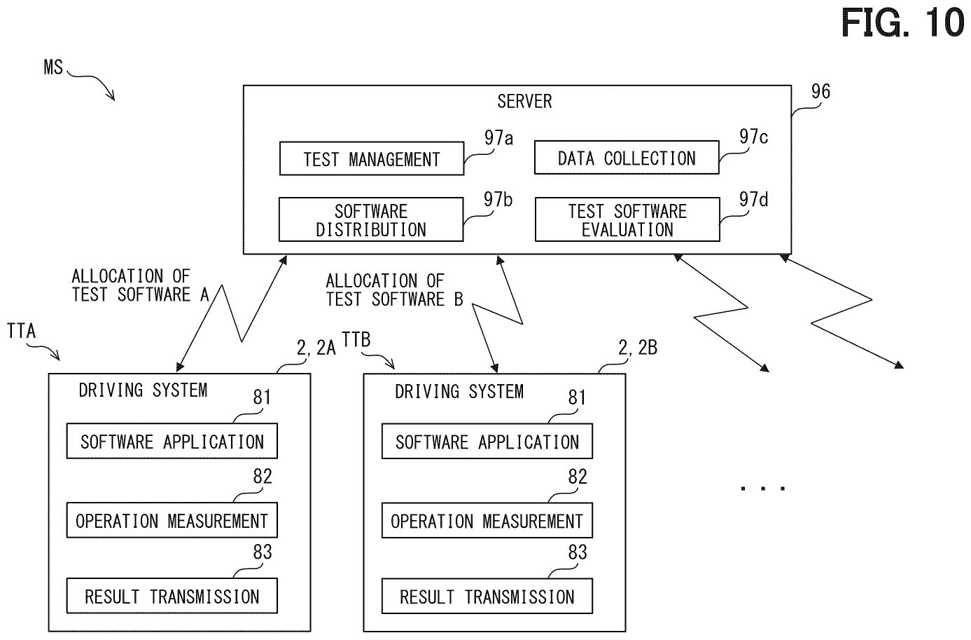

In order to manage an unacceptable risk and improve the driving system 2, it is preferable that there is a strong management system for the driving system 2 after shipment to the market. For example, a management system MS illustrated in FIG. 10 changes the software for a vehicle population by over-the-air (OTA). The management system MS includes the vehicle population including multiple vehicles TTA and TTB, and the server 96. The vehicles TTA and TTB managed by the management system MS may have the same configuration as the vehicle 1 including the driving system 2 described above, and some of the hardware specifications such as the vehicle type and the vehicle model may be different from each other as long as there is compatibility in the software specifications at least.

In the test in the change process, an index related to safety is used. The result of the validation using the index related to safety may not be used only to determine whether the test software is applicable. For example, the result may be used to set the ODD itself or to set parameter restrictions by the ODD.

### (Configuration Example of Server)

As shown in FIG. 2, the server 96 is installed in an external environment for the vehicles TTA and TTB. The server 96 is communicably connected to the vehicles TTA and TTB by, for example, V2X communication via a communication infrastructure. The management system MS executes a software test for improvement in safety. That is, the management system MS may be an improvement system that improves the performance or safety of the driving systems 2A and 2B. The software here may include an algorithm in a computer program used in the driving systems 2A and 2B. The software here may include parameters in a computer program used in the driving systems 2A and 2B. The software here may include AI or a learning model such as a neural network used in the driving systems 2A and 2B.

As illustrated in FIG. 2, the server 96 may be mainly implemented by a dedicated computer including at least one memory 96a and at least one processor 96b. The memory 96a may be, for example, at least one type of non-transitory tangible storage medium, such as a semiconductor memory, a magnetic medium, and an optical medium, which non-temporarily stores a computer program, data, and the like that can be read by the processor 96b. For example, a rewritable volatile storage medium such as a random access memory (RAM) may be provided as the memory 96a. The processor 96b includes, for example, at least one type of a central processing unit (CPU), a graphics processing unit (GPU), and a reduced instruction set computer (RISC)-CPU as a core.

The dedicated computer may be a system on a chip (SoC) in which the memory 96a, the processor 96b, and an interface are integrally implemented on one chip, or at least one SoC may be provided as an element of the dedicated computer.

The server 96 may further include a management database (hereinafter, the management DB) 96c. The management DB 96c may store information for specifying the vehicles TTA and TTB to be managed by the management system MS. The management DB 96c may store information on specifications of the vehicles TTA and TTB. The management DB 96c may store various types of information collected from the vehicles TTA and TTB. The various types of information may include information for executing an evaluation in a test for improving safety to be described below.

The server 96 implements a safety improvement functionality for improving the safety. As illustrated in FIG. 10, the server 96 may include a test management unit 97a, a software distribution unit 97b, a data collection unit 97c, and a test software evaluation unit 97d as processing units for implementing the safety improvement functionality by the processor 96b executing a computer program.

The test management unit 97a manages a test executed for safety improvement. The test may be a test for determining the best software among multiple pieces of test software. When two types of test software are prepared and the two types of test software are compared with each other, this test is referred to as an AB test. The multiple pieces of test software may be three or more types of software that have similar functionalities and can be compared with one another.

The test software is provided by, for example, a human administrator (hereinafter, a test administrator) of the server 96. In this case, the test is conducted for the purpose of selecting the optimum software from the software as a release candidate. On the other hand, when the test is conducted to optimize the parameters used for the computer program, the test software may be software automatically generated by the test management unit 97a in a form of changing the parameters of the existing program.

The test management unit 97a manages the scale of the test and the period of the test. The scale and the period may be set to values input to the server 96 by the test administrator, or may be automatically set by the test management unit 97a. The test management unit 97a determines a test target vehicle suitable for conducting the test from the vehicles TTA and TTB belonging to the vehicle population based on the scale and the period. When the number of vehicles incorporated in the management system MS is smaller than the optimum scale for conducting the test, all the vehicles TTA and TTB belonging to the vehicle population may be designated as the test target vehicles.

The test management unit 97a allocates one of the multiple pieces of test software to the test target vehicle among the vehicles TTA and TTB belonging to the vehicle population. For example, in a test for comparing test software A and test software B, half of the test target vehicles test the test software A, and the remaining half of the vehicles test the test software B. The test management unit 97a may randomly allocate the test software to the vehicles TTA and TTB using a pseudo-random number. The test management unit 97a may refer to vehicle information stored in the management DB 96c and execute the allocation of the test software so as to reduce the bias of the condition between the groups for testing the test software.

The test management unit 97a sets at least one evaluation index for evaluating the test software. The evaluation index is used to determine, for example, whether the test software can be adopted. The evaluation index may be set, based on the functionalities and properties of the test software or the intention of the test, to an index determined by the input operation of the test administrator to the server 96. Alternatively, the evaluation index may be set by the test management unit 97a based on the functionalities and properties of the test software.

The evaluation index includes an index related to safety. The index related to safety may be a value obtained by indexing the risk checked by the risk checking unit 26. The value obtained by indexing the risk includes, for example, the risk value, the safety envelope, the safety distance, and the violation metric (violation degree). The violation metric (violation degree) is a value obtained by evaluating the degree of violation of the vehicle 1 (test target vehicle) with respect to the rule stored in the rule set.

The index related to safety may be a safety metric of the automated driving system. The safety metric may mean a scale that can be quantified based on a collision rate. Examples of the safety metric include the severity and frequency of collision, the severity and frequency of citable offences, the distances in the vertical direction and the lateral direction, the accelerations in the vertical direction and the lateral direction, the jerk in the vertical direction and the lateral direction, the OEDR response time, and the like. The severity of the collision may be evaluated in six stages using, for example, abbreviated injury scale (AIS). The distances in the longitudinal direction and the lateral direction are indexes related to maintenance of a safety envelope or a safety distance.

The index related to safety may be a human evaluation related to safety. The human herein may be a driver or an occupant of the test target vehicle. In this case, the evaluation related to safety is an evaluation input by the driver or the like through the HMI device 70 of the test target vehicle. The human herein may be another VRU such as a pedestrian who encounters the test target vehicle. In this case, the evaluation related to safety may be an evaluation transmitted to the driving systems 2A and 2B or the server 96 by another VRU who feels that the test target vehicle is hazardous using the mobile terminal 91 or the like owned by the VRU.

The software distribution unit 97b distributes the test software to the driving system 2 of the test target vehicle based on the allocation of the test software set by the test management unit 97a. Information on a plan of the test may be distributed together with the distribution of the test software. The information on the plan of the test includes information on a period and an evaluation index of the test, and may further include information such as a scale of the test. Accordingly, the test software distributed by each of the driving systems 2A and 2B is temporarily applied, and the test is started.

The data collection unit 97c collects information on an operation of the test software or an operation result thereof as probe data from each of the driving systems 2A and 2B to which the test software is temporarily applied. The information to be collected includes at least one of an index itself related to safety and information for deriving the index related to safety. The data collection unit 97c accumulates the data sequentially collected from the vehicles TTA and TTB in the management DB 96c.

The test software evaluation unit 97d compares multiple pieces of test software. The test software evaluation unit 97d compares an evaluation index set by the test management unit 97a between pieces of test software. When there are multiple evaluation indexes, the test software evaluation unit 97d compares each of evaluation indexes between pieces of test software.

Specifically, the test software evaluation unit 97d statistically processes the data from the vehicles TTA and TTB accumulated in the management DB 96c. For example, when the evaluation index can be expressed by a ratio such as an occurrence rate, the test software evaluation unit 97d calculates an occurrence rate per vehicle and/or per unit time from the occurrence frequency in the data from the vehicles TTA and TTB.

In the evaluation using the safety metric as the evaluation index, it is preferable to consider severity potential. In the case of evaluating the severity and frequency of a collision for the test software, even if the test software is temporarily applied to multiple vehicles TTA and TTB, it is difficult to statistically evaluate the severity and frequency of a collision when there are few cases in which a collision actually occurs. Therefore, the test software evaluation unit 97d may estimate a rate of serious collisions having a high severity from the occurrence rate of proper precursor events such as a near collision and a collision with a low severity.

The distribution and sensitivity of the collision type may be different between an automated driving system and a human driver. Therefore, in the statistical evaluation of the safety metric for the test software, the evaluation may be performed after the vehicles to which the test software is applied are classified into an automated driving vehicle of level 3 or higher and a vehicle driven by a driver.

The test software evaluation unit 97d may have a functionality of selecting one piece of optimum test software from multiple pieces of test software. The optimum test software may be test software with the highest safety. The test management unit 97a may determine the test software selected by the test software evaluation unit 97d as formal software to be formally adopted. Based on this determination, the software distribution unit 97b may distribute the formal software to the vehicles TTA and TTB belonging to the vehicle population. The distribution destination vehicle may include a vehicle that belongs to the vehicle population and is not the test target vehicle.

When the multiple pieces of test software are an improvement plan of a currently applied software that is formally applied to each of the vehicles TTA and TTB, the test software evaluation unit 97d may execute a relative evaluation of the selected test software with respect to the currently applied software. The test software evaluation unit 97d may determine that the selected test software does not have higher performance than the currently applied software. In this case, the test management unit 97a may exclude all of the multiple pieces of test software from formal software to be formally adopted.

On the other hand, the test software evaluation unit 97d may not have a functionality of selecting the optimum test software. In this case, the test management unit 97a presents a comparison result of an evaluation index to the test administrator through the HMI, and receives an input operation of the selection result of the formal software to be formally adopted by the test administrator. In accordance with this input operation, the test management unit 97a determines the formal software. Based on this determination, the software distribution unit 97b may distribute the formal software to the vehicles TTA and TTB belonging to the vehicle population.

### (Configuration Example of Driving System)

Driving systems 2A and 2B are implemented in each of the vehicles TTA and TTB belonging to the vehicle population. The driving systems 2A and 2B implement a safety-improving functionality in addition to the perception functionality, the planning functionality, and the acting functionality described above. The safety-improving functionality is a functionality of improving the safety of the driving systems 2A and 2B. The driving systems 2A and 2B may each include a software application unit 81, an operation measurement unit 82, and a result transmission unit 83 as processing units for implementing a safety-improving functionality by the processor 51b executing a computer program.

The software application unit 81 manages application of software implemented in the driving systems 2A and 2B. The application of the software here may be making the software available for use, that is, installation of the software. The management of the application of the software may include defense against external attacks that exploit security vulnerabilities and management of software updates. When the formal software is distributed, the software application unit 81 permanently applies the formal software to the driving systems 2A and 2B. The permanent application herein means application until the next update of the formal software.

The management of the application of software may include management of the application of test software. When the vehicles TTA and TTB are selected as the test target vehicles, the software application unit 81 temporarily applies the test software distributed from the server 96 to the driving systems 2A and 2B, and starts verification of the test software.

The software application unit 81 may stop or end the application of the test software to the driving systems 2A and 2B. For example, when the test period is completed, the application of the test software is ended. For example, even during the test period, when the formal software to be formally adopted is determined, the application of the test software is ended. For example, when the test itself is stopped due to a serious problem of the test software, the application of the test software is stopped. Further, for example, when the vehicles TTA and TTB leave or are excluded from the test target vehicle due to a problem such as a contract, the application of the test software is ended.

The operation measurement unit 82 measures an operation result of the temporarily applied test software. The measurement target is at least one of an evaluation index designated from the server 96 side and data necessary for calculation of the evaluation index. As described above, the evaluation index includes an index related to safety. The measurement of the operation result may be constantly conducted according to the properties of the evaluation index, or may be conducted only in a predetermined case based on a preset trigger.

The result transmission unit 83 transmits results of a test to the server 96. The results of the test may be sequentially transmitted in the progress of the test, or may be collectively transmitted at the end of the test period. The results of the test include at least one of test software application information to the driving systems 2A and 2B by the software application unit 81 and measurement information measured by the operation measurement unit 82. The test software application information may include a date and time and a period when the test software is applied to the driving systems 2A and 2B, a method of applying the test software to the driving systems 2A and 2B, and the like. The measurement information is information on the measurement target described above.

One of the operation measurement unit 82 and the result transmission unit 83 may record the results of the test in the storage medium 55c. A transmission log to the server 96 may be recorded in the storage medium 55c together with the results of the test.

As described above, the operation measurement unit 82 selects an index or data to be measured and an acquisition source from which the index or data is acquired, that is, a measurement target, based on the information of the evaluation index received from the server 96. Then, the operation measurement unit 82 generates the measured index or data in the form of measurement information according to a preset format. This format may be designated from the server 96 in the information of the evaluation index. The generated measurement information can be transmitted to the server 96 as probe data and recorded in the storage medium 55c as described above.

### (Flow of Test)

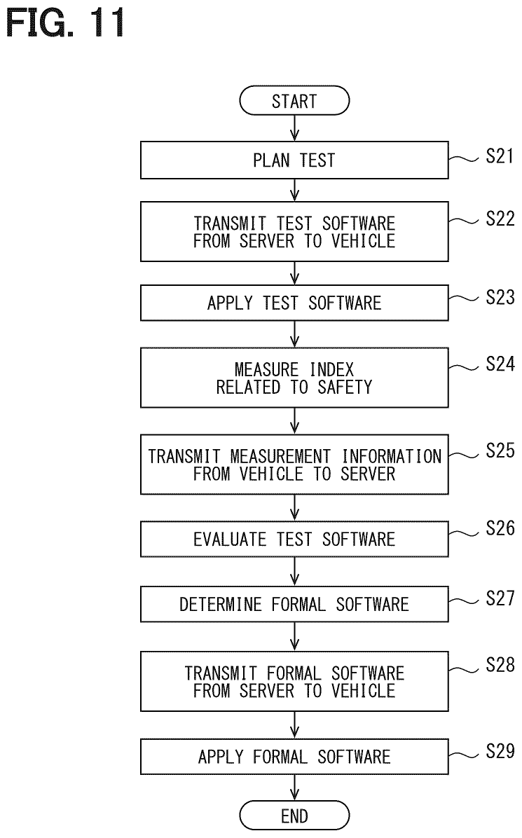

Here, an example of a test conducting method for improving safety will be described with reference to the flowchart in FIG. 11. The test conducting method for improving safety can also be said to be a method of improving the driving system. This processing may be implemented, for example, by the processor 96b of the server 96 executing a computer program stored in the memory 96a and the processor 51b of the processing system 50 executing a computer program stored in the memory 53a. A trigger for starting the process and a trigger for advancing each step may be given by an input operation of the test administrator to the HMI of the server 96.

In the first S21, a test is planned in the server 96. The test planning includes at least one, preferably all, of the determination of the scale of the test and the test period described above, the determination of the test target vehicle, the allocation of the test software, and an evaluation method of the test software. After the process in S21, the process proceeds to S22.

In S22, the server 96 transmits the test software to each test target vehicle based on the allocation of the test software in the test target vehicle. After the process in S22, the process proceeds to S23.

In S23, the test software is temporarily applied in the driving systems 2A and 2B of each test target vehicle. After the process in S23, the process proceeds to S24.

In S24, under the application of the test software, an index related to safety or data necessary for calculation of the index related to safety is measured in each of the driving systems 2A and 2B. After the process in S24, the process proceeds to S25.

In S25, each of the driving systems 2A and 2B transmits the measurement information measured in S24 to the server 96. In this way, the server 96 collects the measurement information from each test target vehicle in a form that enables a statistical process. After the process in S25, the process proceeds to S26.

In S26, the test software is evaluated in the server 96. That is, a comparison for each piece of test software is conducted for the index related to safety. After the process in S26, the process proceeds to S27.

In S27, on the server 96 side, the formal software to be formally adopted is determined based on the evaluation result in S26. After the process in S27, the process proceeds to S28.

In S28, the formal software is transmitted from the server 96 to each of the vehicles TTA and TTB. After the process in S28, the process proceeds to S29.

In S29, formal software is applied to each of the vehicles TTA and TTB. The series of processes is ended after the above step.

In the distribution process of the test software in S22, a time difference may be provided in the distribution timing to each test target vehicle in order to reduce the communication load. In order to minimize damage when a failure in the test is found after the start of the test, the test software may be distributed to only some of the test target vehicles at the start of the test. In this case, the timings of the processes of S22 to S25 vary depending on the test target vehicle, and may be reversed.

The measurement process in S24 and the measurement information transmission process in S25 may be repeatedly executed a plurality of times in one test target vehicle. The test software evaluation process in S26 does not need to be executed after all the test target vehicles complete the process in S25, and may be executed at a timing when some of the test target vehicles execute the process in S25. The evaluation of the test software may be updated when additional measurement information is received.

### (Conduction of Test Using Shadow-Mode)

When software related to the safety of automated driving is tested by the actual vehicles TTA and TTB, it is necessary to prevent the vehicles TTA and TTB from falling into a hazardous situation during the test. In the following, some application methods of test software for achieving this object will be described.

For temporary application of test software for verification, a shadow-mode can be used as an example. In the shadow-mode, the test software operates in parallel behind the scenes against the software operating according to the currently applied formula. The output result of the test software is not reflected in the behavior of the vehicles TTA and TTB. However, it is possible to verify the test software by executing the same input as the input to the actual software on the test software and evaluating the output of the test software by an index related to safety.

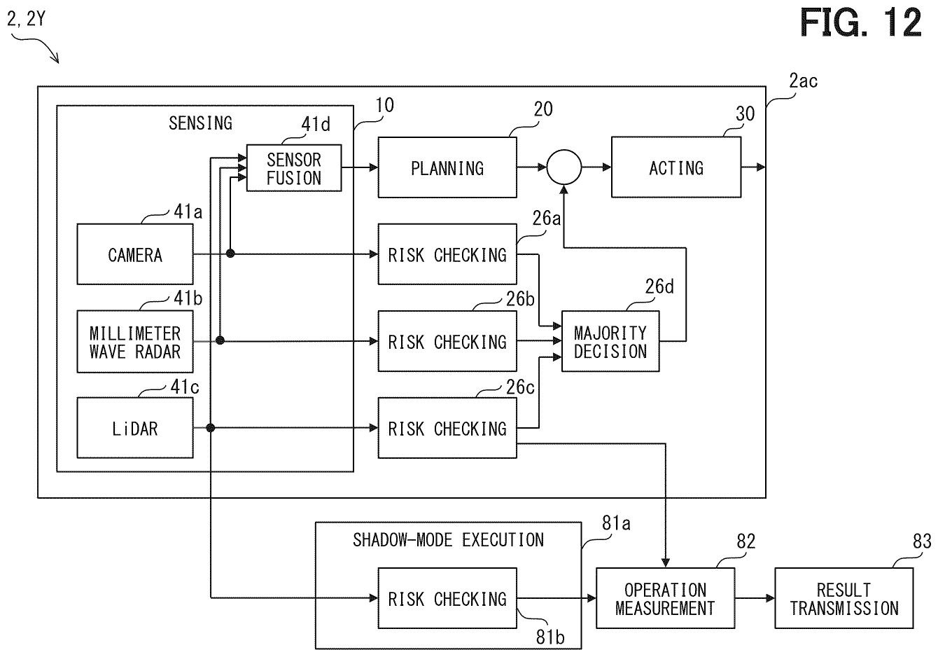

In FIG. 12, a configuration is adopted in which a driving system 2Y as a specific example of the systems 2A and 2B applicable to the vehicles TTA and TTB is separated into an actual operation unit 2ac and a shadow-mode execution unit 81a. The actual operation unit 2ac and the shadow-mode execution unit 81a may be configured such that, for example, pieces of hardware are separate and independent. For example, a computer including a memory and a processor constituting the shadow-mode execution unit 81a may be provided separately from a main computer of the processing system 50. The actual operation unit 2ac and the shadow-mode execution unit 81a may share, for example, hardware resources. In this case, in a computer in which a computer program for the actual operation unit 2ac in the processing system 50 is incorporated, a computer program for the shadow-mode execution unit 81a is incorporated separately from the computer program for the actual operation unit 2ac to execute the process.

The actual operation unit 2ac is configured to reflect the process on at least one of the HMI, the V2X communication, and the behavior of the actual vehicles TTA and TTB. That is, a series of configurations described in the architecture of the driving system 2 described above is provided. The actual operation unit 2ac may include, for example, a redundant system shown in FIG. 9. On the other hand, the shadow-mode execution unit 81a is configured to restrict the process from being reflected in the HMI and the behavior of the actual vehicles TTA and TTB. The shadow-mode execution unit 81a can provide information on the operation of the test software for the probe data collection by the server 96, which is not directly reflected in the HMI and behavior of the vehicles TTA and TTB.

FIG. 12 illustrates an example in which the shadow-mode is used to improve one risk checking unit 26c among the plurality of risk checking units 26a, 26b, and 26c in the actual operation unit 2ac according to the configuration illustrated in FIG. 9. In this example, the shadow-mode execution unit 81a includes a risk checking unit 81b corresponding to the risk checking unit 26c on the actual operation unit 2ac side. This risk checking unit 81b is different from the risk checking unit 26c on the actual operation unit 2ac side. The test software in a test executed for safety improvement is applied to the risk checking unit 81b. Therefore, the software applied to the risk checking unit 26c on the actual operation unit 2ac side corresponds to the software corresponding to the test software applied to the risk checking unit 81b.

The risk checking unit 81b is configured to receive the same information at substantially the same timing as the risk checking unit 26c on the actual operation unit 2ac side. The sensing result of the LiDAR 41c is input to the risk checking unit 26c, and therefore, the same sensing result of the LiDAR 41c is also input to the risk checking unit 81b.

The operation measurement unit 82 measures at least one of the data indicating the situation, the checking result of the situation (including the checking results of the risk), and the derived proper response, which are output by the risk checking unit 81b on the shadow-mode execution unit 81a side. The operation measurement unit 82 may further measure at least one of the data indicating the situation, the checking result of the situation, and the derived proper response, which are output by the risk checking unit 26c on the actual operation unit 2ac side. In this case, the operation measurement unit 82 may detect a difference between the output of the shadow-mode execution unit 81a and the output of the actual operation unit 2ac.

The result transmission unit 83 may transmit the outputs of the risk checking units 26c and 81b obtained by the operation measurement unit 82 to the server 96 as they are. The outputs of the risk checking units 26c and 81b obtained by the operation measurement unit 82 may be converted according to the format of the evaluation index set in the test. The result transmission unit 83 may transmit the converted data to the server 96.

### (Conduction of Test Using Redundant System)

As an example, a redundant system can be used to temporarily apply test software for verification. That is, the test software is temporarily applied to one system of the multiple systems forming the redundant system. For example, in the case of a driving system including a redundant system of triple redundancy majority decision, even if one system to which the test software is applied outputs an error (a non-optimal solution for safety), the error due to the test software is rejected by the other two systems. Even in the case of a driving system including a dual-redundant system, a test using the redundant system can be performed as long as safety can be ensured by the remaining one system in the functionality of the test software to be tested. A redundant system based on the triple redundancy majority decision may be adopted in the driving system capable of implementing the driving at an automation level 4 or 5. A redundant system based on dual-redundant majority decision may be adopted in a driving system capable of implementing driving at the automation level 3, and a driving system mounted on a vehicle used for mobility as a service (MaaS) and capable of implementing driving at the automation level 4.

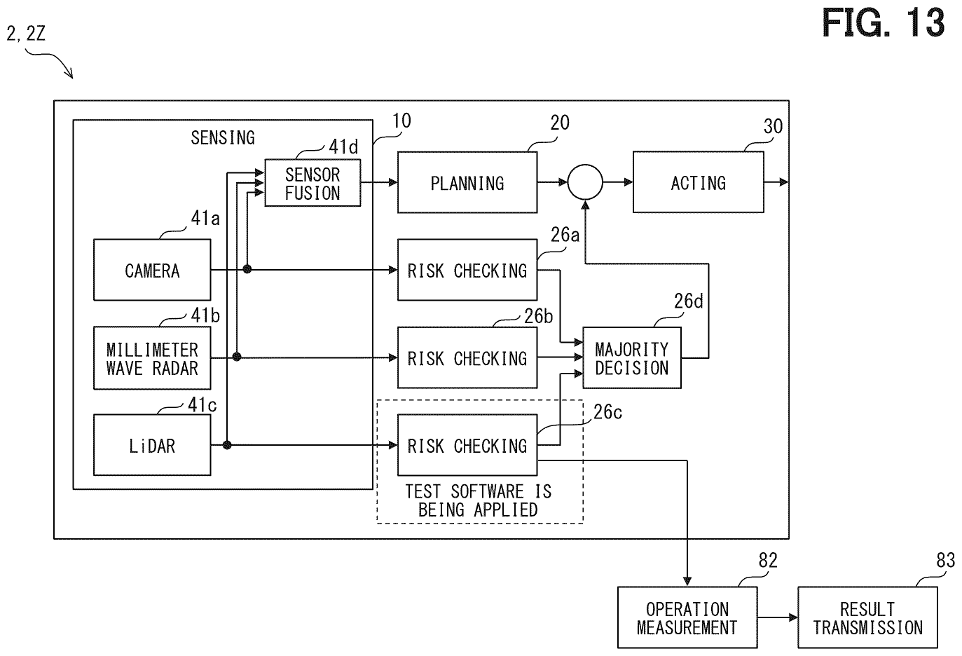

FIG. 13 illustrates a driving system 2Z as a specific example of the systems 2A and 2B applicable to the vehicles TTA and TTB, the driving system 2Z having the redundant system illustrated in FIG. 9. In this driving system 2Z, an example in which a test is performed in order to improve one risk checking unit 26c among the multiple risk checking units 26a, 26b, and 26c is illustrated. In this example, test software is temporarily applied to the risk checking unit 26c to be tested.

The sensing result of LiDAR 41c is input to the risk checking unit 26c as in the case of non-test periods. The checking results of the risk from the risk checking unit 26c based on the test software are aggregated by the majority decision provided by the majority decision unit 26d as in the non-test. The output from the risk checking unit 26c is provided to the operation measurement unit 82.

The operation measurement unit 82 measures at least one of the data indicating the situation, the checking result of the situation (including the checking results of the risk), and the derived proper response, which are output by the risk checking unit 26c. The result transmission unit 83 may transmit the outputs of the risk checking units 26c and 81b obtained by the operation measurement unit 82 to the server 96 as they are. The outputs of the risk checking units 26c and 81b obtained by the operation measurement unit 82 may be converted according to the format of the evaluation index set in the test. The result transmission unit 83 may transmit the converted data to the server 96.

### (Case of Test)

The first test case is a test of software related to the calculation of the RSS model when the RSS model is applied to the risk checking unit 26. The test target is, for example, parameters substituted into an expression in the calculation of the safety distance as shown in the expressions 4, 9, and 14. That is, some pieces of test software in which parameters to be substituted are different from each other are prepared and allocated to the test target vehicle to perform the test. Examples of the parameters include values related to braking, such as a value of a response time, a braking distance, and a reaction distance. The parameters include parameters representing properties of other vehicles or other road users. The change of the parameter for other vehicles or other road users is substantially synonymous with the change of a premise in the reasonably foreseeable assumption regarding the behavior of other vehicles or other road users.

In this test, the evaluation index is, for example, a frequency at which a safety envelope is maintained, in other words, a safety envelope violation occurs. The risk checking unit 26 to which the test software is temporarily applied detects that an inter-vehicle distance between each of the vehicles TTA and TTB and another vehicle is less than the safety distance, that is, the safety envelope violation occurs. Then, the operation measurement unit 82 counts the number of occurrences of the safety envelope violation and calculates the number of occurrences or the frequency based on the number of occurrences. The result transmission unit 83 transmits this frequency to the server 96. The frequency herein may be the number of occurrences per traveling time or the number of occurrences per traveling distance.

The operation measurement unit 82 measures at least one type of information among a situation, a scene, a scenario, an occurrence point, and the like in which the safety envelope violation occurs, together with the frequency of the safety envelope violation, and provides the information to the server 96.

In the server 96, the data collection unit 97c collects information from the multiple test target vehicles. The test software evaluation unit 97d statistically processes the occurrence frequency of the safety envelope violation for each test software. The test software evaluation unit 97d analyzes and visualizes the comparison result between the pieces of test software, including the violation occurrence situation. Based on this, the test management unit 97a causes the test administrator to check the visualized comparison result, and receives an input of the formal software selection result by the test administrator to the server 96. In this way, the formal software is determined in the test management unit 97a.

In the first test case, the above-described content may be limited to a specific scene or scenario. For example, the test may be conducted only in a difficult scene for one of the multiple external environment sensors 41. The test software may be applied to the risk checking unit 26 receiving the sensing information of the sensor corresponding to the difficult scene. For example, in a scene in which sunlight enters the camera 41a as backlight, only the risk checking unit 26a associated with the camera 41a may be tested.

The second test case is a test of software included in the planning unit 20. The test target is, for example, a parameter related to a lane change condition, and is more specifically a threshold for determining whether to execute the lane change. That is, some pieces of test software in which the settings of thresholds are different are prepared and allocated to the test target vehicle to perform the test. The thresholds may be set to the same value without depending on the scene or the scenario, or may be set to values respectively optimized for each scene or scenario.

In this test, the evaluation index is, for example, a frequency at which the safety envelope checked by the risk checking unit 26 is maintained, in other words, the safety envelope violation occurs. In the first test case, both the application target and the measurement target of the test software are the risk checking unit 26, and the application target and the measurement target match. In contrast, in the second test example, the application target is the planning unit 20 and the measurement target is the risk checking unit 26b, and therefore, the application target and the measurement target are different from each other.

Here, the acting unit 30 controls the motions of the vehicles TTA and TTB based on the trajectory plan planned by the planning unit 20. The sensing unit 10 also detects a scene generated based on the behavior by this control, and the risk checking unit 26 checks the sensing result. Therefore, the operation result of the planning unit 20 affects the checking results of the risk. For example, it is assumed that the vehicles TTA and TTB cut into the adjacent lane as a result of the planning unit 20 lowering a threshold of the lane change in a specific scenario. As a result, the sensor such as the camera 41a perceives the approach of other vehicles, and the risk checking unit 26a detects the safety envelope violation. Then, the operation measurement unit 82 counts the number of occurrences of the safety envelope violation and calculates the number of occurrences or the frequency based on the number of occurrences. The result transmission unit 83 transmits the frequency to the server 96. The subsequent process is the same as the process in the first case.

Other evaluation indexes may be adopted in the second test case. For example, the evaluation index may be the severity and frequency of a collision actually occurring during the lane change. For example, the evaluation index may be an evaluation of drivers of the vehicles TTA and TTB regarding safety during the lane change.

The third test case is a test of software that implements an information presentation functionality of the HMI in the acting unit 30. The test target may be display content to be displayed on the HUD as the information presentation device, and may be at least one of display content to be displayed during manual driving by the driver, a combination of the display content, a display timing of the display content, and the like.

More specifically, the test target may be, for example, a mode of display content giving notification of a hazard by the HUD. For example, the test software A may adopt content that clearly and conspicuously displays a hazard. The test software B may adopt content that displays a risk more ambiguously than the test software A. When the hazard is displayed too clearly, the driver may pay too much attention to the display itself, and the execution of other dynamic driving tasks may become uneasy. On the other hand, when the display is ambiguous, the driver may not understand the meaning of the display. What display mode can minimize the risk can be tested.

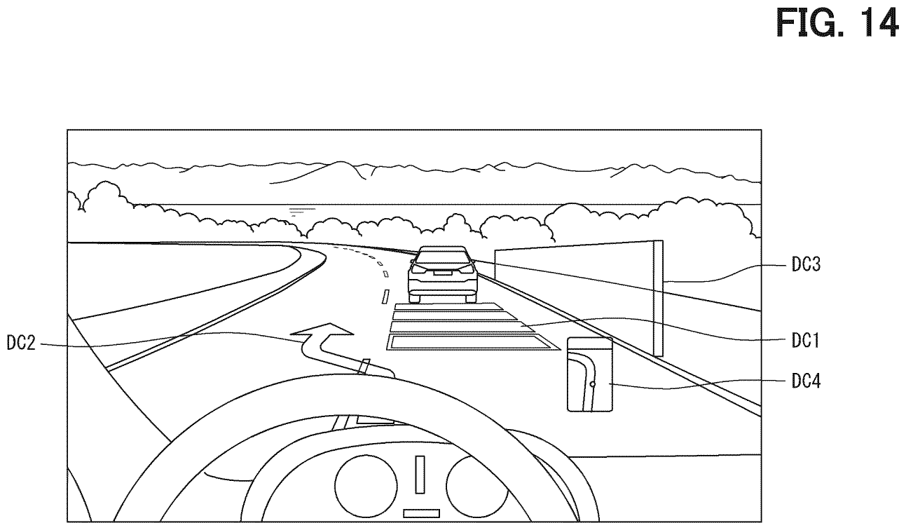

The test may be a comparison between multiple pieces of test software having different numbers of simultaneously displayable display content. For example, FIG. 14 illustrates four types of display content DC1, DC2, DC3, and DC4 in total by the HUD as the display content. These types of display content DC1, DC2, DC3, and DC4 are superimposed and displayed on the external environment in front of the vehicles TTA and TTB. The first display content DC1 is inter-vehicle distance content that displays the inter-vehicle distance to a preceding vehicle. The second display content DC2 is lane change trajectory content that displays a lane change trajectory recommended by the driving systems 2A and 2B. The third display content DC3 is protrusion prevention content that displays a virtual wall or the like for restricting the vehicles TTA and TTB from protruding outside a white line. The fourth display content DC4 is map content that displays map information. The test software A may be software that simultaneously displays a maximum of four types of display content, and the test software B may be software that simultaneously displays a maximum of two types of display content, that is, software on which the number of displays is restricted.

In these tests, the evaluation index may be an evaluation of the driver of the vehicle regarding the safety of the display content. The test related to the HMI is not suitable for the test using the shadow-mode because it is necessary to evaluate interaction with the driver. This test may be directed to the software of a part that does not constitute a redundant system, instead of a test using a part of a superimposed system.

Although one evaluation index is used in each case, multiple evaluation indexes may be combined. By combining multiple evaluation indexes, the test software can be evaluated in a multifaceted manner, and the reliability of the adopted formal software can be improved.

According to the first embodiment described above, multiple different pieces of test software are allocated to the driving systems 2A and 2B in the multiple vehicles TTA and TTB, and a test is executed in each of the driving systems 2A and 2B. An index related to safety measured in each of the driving systems 2A and 2B or data necessary for the calculation of the index is collected by the server 96, and multiple pieces of test software are evaluated by the index related to safety. In this way, the optimum test software can be selected based on the statistical approach, and the optimum test software is applied to each of the vehicles TTA and TTB as formal software. Accordingly, the performance of the driving systems 2A and 2B of the vehicles TTA and TTB can be effectively improved.

According to the first embodiment, the test software is temporarily applied by operating the test software in the shadow-mode in parallel with the corresponding software corresponding to the test software in the driving systems 2A and 2B. By using the shadow-mode, the test can be executed in a mode in which the test software is restricted from being reflected in the HMI and the behavior. Therefore, a test can be properly executed on a functionality that affects the safety of the driving systems 2A and 2B.

According to the first embodiment, both of the index related to the safety or the data necessary for the calculation of the index among the outputs of the corresponding software and the index or the data necessary for the calculation of the index among the outputs of the test software operating in parallel in the shadow-mode are measured in a comparable manner. Therefore, it is possible not only to compare the test software with each other but also to easily evaluate whether the performance is improved with respect to the currently applied software. Therefore, the performance of the driving systems 2A and 2B of the vehicles TTA and TTB can be effectively improved.

According to the first embodiment, the test software is applied to one system among multiple systems forming the redundant system, which is configured such that, even when the one system outputs the non-optimal solution for safety, the non-optimal solution is rejected by another system. Accordingly, the test software is temporarily applied. The test can be executed in a mode in which the non-optimal solution is restricted from being reflected in the HMI and the behavior. Therefore, a test can be properly executed on a functionality that affects the safety of the driving systems 2A and 2B.

According to the first embodiment, the index related to safety or the data necessary for the calculation of the index includes the checking results of the risk by the risk checking units 26, 26a, 26b, and 26c. The risk herein is checked based on the risk acceptance criteria/criterion indicating the acceptable risk level, and therefore, the safety of the tested software and the driving systems 2A and 2B in which the software is adopted can be easily and objectively verified.

According to the first embodiment, the risk checking result includes the frequency of occurrence of violation of the safety envelope. The collision risk of the vehicles TTA and TTB is evaluated using a kinematic violation defined in a space around the vehicles TTA and TTB. Therefore, even if there is no actual collision occurrence, statistical-based evaluations can be performed at the near-miss stage. Therefore, the performance of the driving systems 2A and 2B of the vehicles TTA and TTB can be effectively improved.

### Second Embodiment

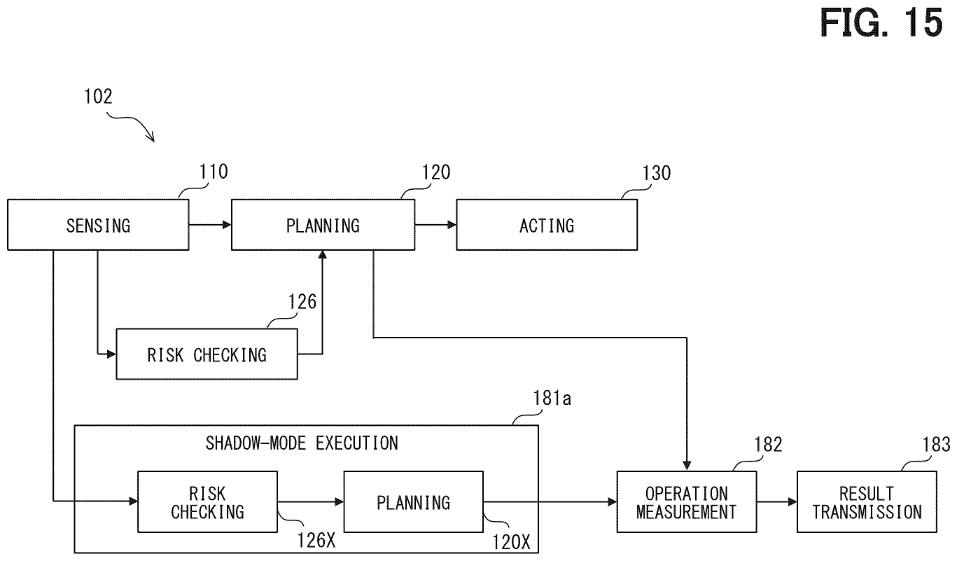

As illustrated in FIG. 15, a second embodiment is a modification example of the first embodiment. The second embodiment will be described focusing on a difference from the first embodiment.

In the second embodiment, a risk checking unit 126 does not derive a proper response, and is mounted specifically for a risk checking functionality. In this example, in a driving system 102, the risk checking unit 126 may be constructed as a processing unit independent of a sensing unit 110, a planning unit 120, and an acting unit 130.

The risk checking unit 126 acquires situation data from the sensing unit 110. The risk checking unit 126 extracts a situation from the situation data and assumes a safety-relevant object or a behavior thereof. The risk checking unit 126 checks the risk with respect to the assumed object or the behavior thereof, and outputs the checking result to the planning unit 120. In order to check the risk here, an RSS model implemented in the risk checking unit 126 in a form of, for example, a program may be used. The risk check may be executed in the same manner as in the first embodiment. The checking result may include a determination result as to whether the risk is acceptable. The checking result may include a numerical value for a safety envelope or a safety distance used by the RSS model in the calculation thereof.

The planning unit 120 plans driving of the vehicles TTA and TTB according to the checking result acquired from the risk checking unit 126. The planning unit 120 may make a comprehensive determination based on the situation data acquired from the sensing unit 110 and the checking result to plan the driving of the vehicles TTA and TTB. Alternatively, the planning unit 120 may plan the driving of the vehicles TTA and TTB based on the situation data acquired from the sensing unit 110, and modify the plan when the risk checking unit 126 gives a notification of existence of an unacceptable risk. The acting unit 130 does not need to directly apply the restriction by the RSS model, and may directly implement the trajectory plan acquired from the planning unit 120 through the motion actuator 60.

A case where software included in the risk checking unit 126 of the driving system 102 is tested using the shadow-mode will be described. A shadow-mode execution unit 181a executes a process by a risk checking unit 126X and a process by a planning unit 120X, to which the test software is temporarily applied, behind the scenes in parallel with the process by the risk checking unit 126 and the process by the planning unit 120. The software applied to the planning unit 120X on the shadow-mode execution unit 181a side may be exactly the same as the software applied to the actual planning unit 120.

The operation measurement unit 182 acquires a trajectory plan output by the planning unit 120X on the shadow-mode execution unit 181a side and a trajectory plan output by the actual planning unit 120. These trajectory plans may be provided to the server 96 by the result transmission unit 183 as they are. The operation measurement unit 182 may detect a difference between the two trajectory plans, and the result transmission unit 183 may provide a detection result of the difference to the server 96. The detection result of the trajectory plan or the difference may correspond to one of data necessary for calculating an index for evaluating safety of autonomous traveling.

### Third Embodiment

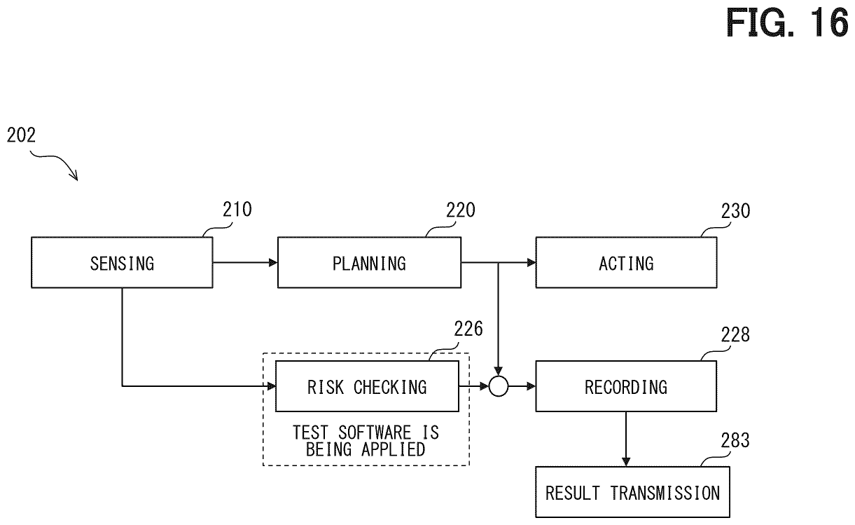

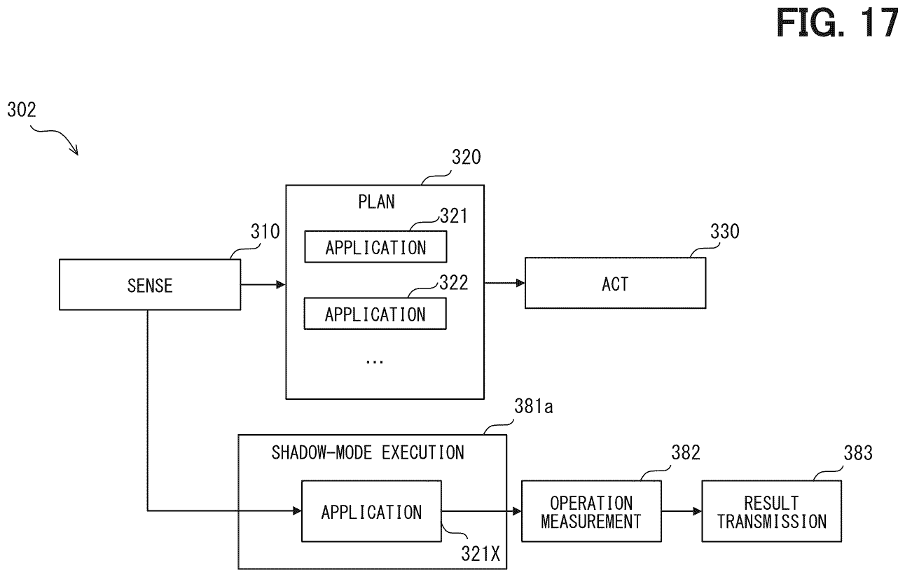

As illustrated in FIG. 16, a third embodiment is a modification example of the first embodiment. The third embodiment will be described focusing on a difference from the first embodiment.

In the third embodiment, a risk checking unit 226 may be mounted specifically for a recording functionality, and not for use in deriving driving and an act of the vehicle 1, for use in subsequent verification and validation of a driving system 202. In this example, in the driving system 202, the risk checking unit 226 and a recording unit 228 may be constructed as functional blocks separate from a sensing unit 210, a planning unit 220, and an acting unit 230.

The risk checking unit 226 acquires situation data from the sensing unit 210. The risk checking unit 226 assumes a safety-relevant object or a behavior thereof, and executes a risk checking using the RSS model, in the same manner as in the second embodiment. The risk checking unit 226 provides a checking result to the recording unit 228. The risk checking unit 226 may be implemented by the dedicated computer 51 of the processing system 50.

The recording unit 228 organizes the processing result by the planning unit 220 and the checking result by the risk checking unit 226, and executes recording sequentially or periodically. The recording may be recording to the on-board storage medium 55c.

The recording unit 228 may generate data that conforms to a data format of a data storage system for automated driving (DSSAD) when organizing the processing result by the planning unit 220 and the checking result by the risk checking unit 226. When the data format of the DSSAD does not support recording of the risk checking result, an extended data format suitable for recording of the risk checking result may be adopted. When the data format of the DSSAD does not support recording of the risk checking result, the risk checking result may be generated as separate dedicated data. In the present embodiment, the recording unit 228 has a functionality corresponding to the operation measurement unit 82 according to the first embodiment.

A case where software included in the risk checking unit 226 of the driving system 202 is tested will be described. The test software is temporarily applied to the risk checking unit 226 as it is. The risk checking unit 226 is specialized in a recording functionality and does not affect the behavior of the vehicles TTA and TTB. Therefore, the test may not be executed using the shadow-mode, and the test may not be executed using the redundant system. The data recorded by the recording unit 228 is provided to the server 96 by the result transmission unit 283.

### Fourth Embodiment

As illustrated in FIG. 17, a fourth embodiment is a modification example of the first embodiment. The fourth embodiment will be described focusing on a difference from the first embodiment.

In a driving system 302 of the fourth embodiment, there is no risk checking unit provided independently of a sensing unit 310, a planning unit 320, and an acting unit 330. The planning unit 320 is able to execute multiple applications 321 and 322 for implementing a functionality of automated driving or a functionality of driving assistance. Examples of the applications 321 and 322 may include an adaptive cruise control (ACC) application that implements a functionality of following another vehicle while maintaining a lane, a lane trace control (LTC) application that implements a functionality of automatically changing lanes of the vehicles TTA and TTB, an advanced emergency braking (AEB) application that implements a functionality of avoiding a collision with another road user by braking, an advanced emergency steering (AES) application that implements a functionality of avoiding a collision with another road user by steering, and the like. In each application, a constraint optimizing the functionality of the application, which is a constraint for avoiding a risk, is set.

A case where software included in one specific application 321 of such a driving system 302 is tested using the shadow-mode will be described. A shadow-mode execution unit 381a executes a process of the specific application to which the test software is temporarily applied behind the scenes in parallel with the process of the specific application in the planning unit 320.

The operation measurement unit 382 acquires a result output by a specific application 321X in the shadow-mode execution unit 381a, and the result transmission unit 383 provides the result to the server 96. The operation measurement unit 382 may acquire a result output by a specific application 321 in the planning unit 320, and the result transmission unit 383 may provide the result to the server 96. The operation measurement unit 382 may detect a difference between the results output by these specific applications 321 and 321X and provide the detection result of the difference to the server 96 by the result transmission unit 383. The detection result of the output or the difference may correspond to one of pieces of data necessary for calculating an index for evaluating the safety of autonomous traveling.

### OTHER EMBODIMENTS

Although a plurality of embodiments are described above, the present disclosure is not construed as being limited to these embodiments, and can be applied to various embodiments and combinations within a scope that does not depart from the gist of the present disclosure.

In the server 96, the plurality of pieces of test software may be compared and the formal software may not be determined. That is, the server 96 may be configured to execute the process up to the collection of measurement information (up to S25 in FIG. 11). For example, the measurement information collected by the data collection unit 97c may be taken into a personal computer of a test administrator, and the test administrator may evaluate the test software by the personal computer. In this case, after the test administrator determines the formal software, the formal software may be distributed using a server different from the test server 96. The other server herein may be included in the management system MS. In a configuration in which the server 96 executes the process up to the collection of measurement information, a system including the multiple vehicles TTA and TTB and the server 96 may be referred to as a data collection system. The server 96 in the data collection system may be referred to as a data collection device.

When there is no test software to be adopted as formal software as a result of the evaluation of the test software, the improvement in the driving system may be stopped. When there is no test software to be adopted as the formal software as a result of the evaluation of the test software, the test may be executed again using corrected test software. The number of pieces of test software used for the retest may be one or more. When the test software to be adopted as the formal software is obtained as a result of the retest, the test software may be determined as the formal software.

The server 96 may allocate multiple pieces of test software to one test target vehicle and distribute the multiple pieces of allocated test software to the driving system 2 of the test target vehicle. The driving system 2 may test the multiple pieces of distributed test software in an order designated by the server 96 or in an order determined by the driving system 2. The driving system 2 may alternately test the two pieces of distributed test software. The driving system 2 may select test software to be tested from multiple pieces of test software, test the selected test software, and stop a test of excluded test software without selection.

The server 96 may not prepare multiple pieces of test software, but may prepare only one piece of test software. In this case, the server 96 may distribute the same single piece of test software to all the test target vehicles. In this case, the evaluation of the test software by the server 96 or the test administrator may be an absolute evaluation of one piece of software instead of a relative comparison of multiple pieces of software. This absolute evaluation may be for determining whether to adopt the test software, or may be an evaluation as reference information for optimizing the software. In this absolute evaluation, when it is not determined that the test software needs to be adopted as the formal software, the test may be executed again using the corrected test software, or the improvement in the driving system 2 may be stopped.

The vehicles 1, TTA, and TTB on which each of the driving systems 2, 2A, 2B, 2X, 2Y, 2Z, 102, 202, and 302 is mounted are not limited to general private cars, and may be a rental vehicle, a manned taxi vehicle, a ride-sharing vehicle, a freight vehicle, a bus, and the like. The vehicles 1, TTA, and TTB may be right-hand drive vehicles or left-hand drive vehicles. A traffic environment in which the vehicles 1, TTA, and TTB travel may be a traffic environment in which traffic drives on the left side of the road or a traffic environment in which traffic drives on the right side of the road. The driving systems 2, 2A, 2B, 2X, 2Y, 2Z, 102, 202, and 302 according to the present disclosure may be appropriately optimized in consideration of road traffic laws and customs of each country and region, police investigations, prosecutions, criminal and civil lawsuits regarding traffic accidents, and the like.

The control unit and its methods described in the present disclosure may be implemented by one or more dedicated computers comprising processors programmed to execute one or more functions embodied in computer programs. Alternatively, the apparatus and methods described in the present disclosure may be implemented by dedicated hardware logic circuits. Further, the apparatus and methods described in the present disclosure may be implemented by one or more dedicated computers configured by a combination of processors executing computer programs and one or more hardware logic circuits. In addition, the computer program may be stored as instructions executable by a computer on a computer-readable non-transitory tangible recording medium.

### DISCLOSURE OF TECHNICAL CONCEPTS

This specification discloses a plurality of technical concepts described in the following enumerated items. Some items may be described in a multiple dependent form, in which preceding items are alternatively referenced in subsequent items. These items described in a multiple dependent form define a plurality of technical concepts.

### Technical Idea 1

A driving system for implementing a dynamic driving task of a vehicle by executing a plurality of pieces of software by at least one processor includes: a communication system mounted on the vehicle and configured to communicate with a server; the at least one processor; and at least one storage medium configured to store the plurality of pieces of software.

The at least one processor acquires allocated test software related to execution of the dynamic driving task via the communication system from the server, temporarily applies the test software to the at least one storage medium, measures an index related to safety or data necessary for calculation of the index in the execution of the dynamic driving task under the application of the test software, transmits measured measurement information to the server via the communication system, acquires, from the server in which formal software to be formally adopted is determined based on the measurement information, the formal software via the communication system, and applies the formal software to the at least one storage medium.

### Technical Idea 2

In the driving system according to Technical Idea 1,
temporarily applying the test software includes operating the test software in a shadow-mode in parallel with corresponding software corresponding to the test software among the plurality of pieces of software.

### Technical Idea 3

In the driving system according to Technical Idea 2,
the measurement includes measuring, in a comparable manner, both the index or the data necessary for calculation of the index among outputs of the corresponding software and the index or the data necessary for calculation of the index among outputs of the test software operating in parallel in the shadow-mode.

### Technical Idea 4

In the driving system according to Technical Idea 1,
temporarily applying the test software includes applying the test software to one system among a plurality of systems forming a redundant system, the one system being configured such that, even when the one system outputs a non-optimal solution for the safety, the non-optimal solution is rejected by other systems.

### Technical Idea 5

The driving system according to any one of Technical Idea 1 to 4 further includes a risk checking unit configured to check a risk occurring in the vehicle based on a risk acceptance criteria/criterion indicating an acceptable risk level. The index or the data necessary for calculation of the index includes a checking result of the risk obtained by the risk checking unit.

### Technical Idea 6

In the driving system according to Technical Idea 5,
the checking result of the risk includes a frequency of occurrence of violation of a safety envelope.

### Technical Idea 7

A server includes at least one processor and is communicably connected to a plurality of vehicles each equipped with a driving system. The at least one processor sets a plurality of pieces of test software to be tested on the driving system, allocates one of the plurality of pieces of test software to each of the plurality of vehicles, and transmits the allocated test software to each driving system, performs a measurement in each driving system under temporary application of the allocated test software from among the plurality of pieces of test software and collects measurement information including an index related to safety or data necessary for calculation of the index from each driving system, analyzes the index related to safety for each piece of the test software based on the measurement information and determines one of the plurality of pieces of test software to be formally adopted as formal software, and distributes the formal software to each driving system.

According to this technical idea, multiple different pieces of test software are allocated to driving systems in multiple vehicles, and a test is executed in each driving system. An index related to safety measured in each driving system or data necessary for calculation of the index is collected by a server, and multiple pieces of test software are evaluated by the index related to safety. In this way, the optimum test software can be selected based on the statistical approach, and the optimum test software is distributed to each vehicle as formal software. Accordingly, the performance of the driving system of each vehicle can be effectively improved.

### Technical Idea 8

A method generates data to be provided to a server. The method is executed by at least one processor provided in a driving system mounted on a vehicle. The method includes, by the processor: acquiring software related to execution of a dynamic driving task and information on an evaluation index for evaluating the software from the server via a communication system; selecting a measurement target including an index related to safety or data necessary for calculation of the index based on the information on the evaluation index; measuring the index or the data necessary for the calculation of the index under application of the software; and generating a measurement result as data in a format specified by the server, which is included in the information on the evaluation index and can be transmitted to the server via the communication system.

According to this technical idea, the information on the evaluation index is provided from the server to the driving system together with the software, and the measurement target for evaluating the software provided by the driving system to the server is selected based on the information. Transmission of data unnecessary for an evaluation of software can be restricted by generating data based on this selection, so that a communication load can be reduced.

### Technical Idea 9

An improvement system, which is a data collection system for collecting data to improve a driving system is provided. The data collection system includes a plurality of vehicles each equipped with the driving system, and a server communicably connected to the plurality of vehicles. The server sets a plurality of pieces of test software to be tested on the driving system, and allocates one or more from among the plurality of pieces of test software to each of the plurality of vehicles, and transmits the allocated test software to each driving system. Each driving system temporarily applies the allocated test software from among the plurality of pieces of test software, and measures an index related to safety or data necessary for calculation of the index under the application of the test software, and transmits measured measurement information to the server.

### Technical Idea 10

A driving system implements a dynamic driving task of a vehicle by executing a plurality of pieces of software by at least one processor. The driving system includes: a communication system mounted on the vehicle and configured to communicate with a server; the at least one processor; and at least one storage medium configured to store the plurality of pieces of software. The at least one processor acquires allocated test software related to execution of the dynamic driving task via the communication system from the server, temporarily applies the test software to the at least one storage medium, measures an index related to safety or data necessary for calculation of the index in the execution of the dynamic driving task under the application of the test software, and transmits measured measurement information to the server via the communication system.

### Technical Idea 11

A server includes at least one processor and communicably connected to a plurality of vehicles each equipped with a driving system. The at least one processor sets a plurality of pieces of test software to be tested on the driving system, allocates one or more from among the plurality of pieces of test software to each of the plurality of vehicles, and transmits the allocated test software to each driving system, and performs a measurement in each driving system under temporary application of the allocated test software from among the plurality of pieces of test software and collects measurement information including an index related to safety or data necessary for calculation of the index from each driving system.

According to these technical ideas 9 to 11, one or more different pieces of test software are allocated to the driving system in the plurality of vehicles, and a test is executed in each driving system. An index related to safety measured in each driving system or data necessary for the calculation of the index is collected by the server. An index related to safety under application of each test software can be compared and examined by using the collected data, and therefore, the index related to safety contributes to effective improvement in performance of the driving system.

### Technical Idea 12

A data collection system collects data to improve a driving system. The data collection system includes: a plurality of vehicles each equipped with the driving system; and a server communicably connected to the plurality of vehicles. The server sets test software to be tested on the driving system, and transmits the test software to each driving system. Each driving system temporarily applies the test software, and measures an index related to safety or data necessary for calculation of the index under the application of the test software, and transmits the measured measurement information to the server. The server analyzes the index related to safety based on the measurement information collected from each driving system, and evaluates the test software.

### Technical Idea 13

A server includes at least one processor and communicably connected to a plurality of vehicles each equipped with a driving system. The at least one processor sets test software to be tested on the driving system, and transmits the test software to each driving system, performs a measurement in each driving system under temporary application of the test software and collects measurement information including an index related to safety or data necessary for calculation of the index from each driving system, and analyzes the index related to safety based on the measurement information and evaluates the plurality of pieces of test software.

According to these technical ideas 12 and 13, the test software is transmitted to the driving systems in a plurality of vehicles, and a test is executed in each driving system. An index related to safety measured in each driving system or data necessary for calculation of the index is collected by a server, and the test software is evaluated by the index related to safety. For example, the software can be optimized in response to the evaluation, and thus the performance of the driving system of each vehicle can be effectively improved.

What is claimed is:

1. An improvement system for improving a driving system, the improvement system comprising:
a plurality of vehicles each equipped with the driving system; and
a server communicably connected to the plurality of vehicles,
wherein
the server
sets a plurality of pieces of test software to be tested on the driving system, and
allocates one of the plurality of pieces of test software to each of the plurality of vehicles, and transmits the allocated test software to each of the driving systems,
each driving system
temporarily applies the allocated test software from among the plurality of pieces of test software, and
measures an index related to safety or data necessary for calculation of the index under application of the test software, and transmits measured measurement information to the server,
the server
analyzes the index related to safety for each piece of the test software based on the measurement information collected from each driving system and determines one of the plurality of pieces of test software to be formally adopted as formal software, and
transmits the formal software to each driving system, and
each driving system applies the received formal software.

2. The improvement system according to claim 1, wherein
temporarily applying the test software includes operating the test software in a shadow-mode in parallel with corresponding software corresponding to the test software in the driving system.

3. The improvement system according to claim 2, wherein
the measurement includes measuring, in a comparable manner, both the index or the data necessary for calculation of the index among outputs of the corresponding software and the index or the data necessary for calculation of the index among outputs of the test software operating in parallel in the shadow-mode.

4. The improvement system according to claim 1, wherein
temporarily applying the test software includes applying the test software to one system among a plurality of systems providing a redundant system, the one system being configured such that, even when the one system outputs a non-optimal solution for the safety, the non-optimal solution is rejected by other systems.

5. The improvement system according to claim 1, wherein
the driving system includes a risk checking unit configured to check a risk occurring in the vehicle based on a risk acceptance criteria indicating an acceptable risk level, and
the index or the data necessary for calculation of the index includes a checking result of the risk obtained by the risk checking unit.

6. The improvement system according to claim 5, wherein
the checking result of the risk includes a frequency of occurrence of violation of a safety envelope.

7. An improvement method for improving a driving system, the improvement method being executed by an improvement system including a plurality of vehicles equipped with the driving system, and a server communicably connected to the plurality of vehicles, the improvement method comprising:
by the server, setting a plurality of pieces of test software to be tested on the driving system, allocating one of the plurality of pieces of test software to each of the plurality of vehicles, and transmitting the allocated test software to each of the driving systems;
by each driving system, temporarily applying the allocated test software from among the plurality of pieces of test software, measuring an index related to safety or data necessary for calculation of the index under application of the test software under the application of the test software, and transmitting measured measurement information to the server;
by the server, analyzing the index related to safety for each piece of the test software based on the measurement information collected from each driving system, determining one of the plurality of pieces of test software to be formally adopted as formal software, and transmitting the formal software to each driving system; and
applying the received formal software by each driving system.

8. A driving system for implementing a dynamic driving task of a vehicle by executing a plurality of pieces of software by at least one processor, the driving system comprising:
a communication system mounted on the vehicle and configured to communicate with a server;
the at least one processor; and
at least one storage medium configured to store the plurality of pieces of software, wherein
the at least one processor
acquires allocated test software related to execution of the dynamic driving task via the communication system from the server,
temporarily applies the test software to the at least one storage medium,
measures an index related to safety or data necessary for calculation of the index in the execution of the dynamic driving task under the application of the test software,
transmits measured measurement information to the server via the communication system,
acquires, from the server in which formal software to be formally adopted is determined based on the measurement information, the formal software via the communication system, and
applies the formal software to the at least one storage medium.
